(19) United States
(12) Patent Application Publication
(10) Pub. No.: US 2017/0048647 A1
(43) Pub. Date: Feb. 16, 2017

(54) METHOD FOR DEVICE-TO-DEVICE (D2D) OPERATION EXECUTED BY TERMINAL IN WIRELESS COMMUNICATION SYSTEM AND TERMINAL USING THE METHOD

(71) Applicant: LG ELECTRONICS INC., Seoul (KR)

(72) Inventors: Sunghoon JUNG, Seoul (KR); Hanbyul SEO, Seoul (KR)

(73) Assignee: LG ELECTRONICS INC., Seoul (KR)

(21) Appl. No.: 15/305,635

(22) PCT Filed: May 6, 2015
(86) PCT No.: PCT/KR2015/004516

§ 371 Date: Oct. 20, 2016

Related U.S. Application Data
(60) Provisional application No. 62/075,813, filed on Nov. 5, 2014.
(60) Provisional application No. 61/988,924, filed on May 6, 2014.
(60) Provisional application No. 61/988,925, filed on May 6, 2014.

(51) Int. Cl. H04W 4/00; H04W 72/04

(52) U.S. Cl. CPC H04W 4/005; H04W 72/04; H04W 88/06

(57) ABSTRACT

Provided are a method for a device-to-device (D2D) operation executed by a terminal in a wireless communication system and a terminal using the method. The method is characterized in that if a terminal operating by means of a first radio access technology (RAT) receives service by means of the network of a second RAT, then the terminal generates RAT support information indicating whether D2D operation is supported and transmits the RAT support information to the network of the first RAT.

### BACKGROUND OF THE INVENTION

Field of the Invention

The present invention relates to wireless communication and, more particularly, to a method for D2D operation executed by a terminal in a wireless communication system and a terminal using the method.

Related Art

In International Telecommunication Union Radio communication sector (ITU-R), a standardization task for International Mobile Telecommunication (IMT)-Advanced, that is, the next-generation mobile communication system since the third generation, is in progress. IMT-Advanced sets its goal to support Internet Protocol (IP)-based multimedia services at a data transfer rate of 1 Gbps in the stop and slow-speed moving state and of 100 Mbps in the fast-speed moving state.

For example, 3rd Generation Partnership Project (3GPP) is a system standard to satisfy the requirements of IMT-Advanced and is preparing for LTE-Advanced improved from Long Term Evolution (LTE) based on Orthogonal Frequency Division Multiple Access (OFDMA)/Single Carrier-Frequency Division Multiple Access (SC-FDMA) transmission schemes. LTE-Advanced is one of strong candidates for IMT-Advanced.

There is a growing interest in a Device-to-Device (D22) technology in which devices perform direct communication. In particular, D2D has been in the spotlight as a communication technology for a public safety network. A commercial communication network is rapidly changing to LTE, but the current public safety network is basically based on the 2G technology in terms of a collision problem with existing communication standards and a cost. Such a technology gap and a need for improved services are leading to efforts to improve the public safety network.

The public safety network has higher service requirements (reliability and security) than the commercial communication network. In particular, if coverage of cellular communication is not affected or available, the public safety network also requires direct communication between devices, that is, D2D operation.

D2D operation may have various advantages in that it is communication between devices in proximity. For example, D2D UE has a high transfer rate and a low delay and may perform data communication. Furthermore, in D2D operation, traffic concentrated on a base station can be distributed. If D2D UE plays the role of a relay, it may also play the role of extending coverage of a base station.

Meanwhile, a terminal can move around networks employing different RATs (Radio Access Technologies). For example, in the E-UTRAN (Evoloved-UMTS Terrestrial Radio Access Network), a terminal can hand over to the WLAN (Wireless Local Area Network). As described above, when a terminal changes a first RAT to a second RAT, it can be the case that frequency of the second RAT does not support the D2D operation of the terminal. In this case, the terminal needs to stop the D2D operation. Therefore, continuity of D2D operation may be lost.

### SUMMARY OF THE INVENTION

The present invention provides a method for D2D operation executed by a terminal in a wireless communication system and a terminal using the method.

In one aspect, provided is a method for D2D (Device-to-Device) operation executed by a terminal in a wireless communication system. The method includes generating RAT support information informing of whether the terminal supports D2D operation in case the terminal operating in a first RAT (Radio Access Technology) receives a service from a network of a second RAT and transmitting the RAT support information to the network of the first RAT.

The RAT support information may be transmitted being included in UE (User Equipment)-capability information of the terminal.

The UE-capability information may further include D2D band information indicating a frequency band or a combination of frequency bands in which the terminal supports D2D operation.

The D2D operation may be D2D communication.

In case the terminal receives a service from a network of the second RAT, the RAT support information may inform of whether the terminal supports D2D operation with respect to a frequency band or a combination of frequency bands in which the terminal supports D2D operation.

The first RAT may be E-UTRAN (Evolved-UMTS Terrestrial Radio Access Network), and the second RAT may be UTRAN (UMTS Terrestrial Radio Access Network) or WLAN (Wireless Local Area Network).

In another aspect, provided is a terminal. The terminal includes an RF (Radio Frequency) unit transmitting and receiving a radio signal and a processor operating in conjunction with the RF unit. The processor is configured to generate RAT support information informing of whether the terminal supports D2D operation in case the terminal operating in a first RAT (Radio Access Technology) receives a service from a network of a second RAT and transmit the RAT support information to a network of the first RAT.

According to the present invention, a terminal informs a network employing a first RAT of a RAT and frequency band supporting D2D operation. The network employing the first RAT utilizes the information given by the terminal and hands over the terminal to a network and an appropriate frequency band supporting D2D operation. Therefore, D2D operation can be prevented from being stopped.

### BRIEF DESCRIPTION OF THE DRAWINGS

FIG. 1 shows a wireless communication system to which the present invention is applied.

FIG. 2 is a diagram showing a wireless protocol architecture for a user plane.

FIG. 3 is a diagram showing a wireless protocol architecture for a control plane.

FIG. 4 is a flowchart illustrating the operation of UE in the RRC idle state.

FIG. 5 is a flowchart illustrating a process of establishing RRC connection.

FIG. 6 is a flowchart illustrating an RRC connection reconfiguration process.

FIG. 7 is a diagram illustrating an RRC connection re-establishment procedure.

FIG. 8 illustrates substrates which may be owned by UE in the RRC IDLE state and a substrate transition process.

FIG. 9 shows a basic structure for ProSe.

FIG. 10 shows the deployment examples of types of UE performing ProSe direct communication and cell coverage.

FIG. 11 shows a user plane protocol stack for ProSe direct communication.

FIG. 12 shows the PC 5 interface for D2D direct discovery.

FIG. 13 is an embodiment of a ProSe discovery process.

FIG. 14 is another embodiment of a ProSe discovery process.

FIG. 15 illustrates a method for a terminal to perform D2D operation according to one embodiment of the present invention.

FIG. 16 illustrates UE-capability information including D2D band information according to the method 2-a.

FIG. 17 illustrates another example of UE-capability information according to the present invention.

FIG. 18 illustrates a method for D2D operation according to another embodiment of the present invention.

FIG. 19 illustrates a D2D operation method of a terminal according to the present invention.

FIG. 20 illustrates a D2D operation method of a terminal according to one embodiment of the present invention.

FIG. 21 illustrates a D2D operation method of a terminal when a method of FIG. 20 is applied.

FIG. 22 is a block diagram illustrating a terminal in which an embodiment of the present invention is implemented.

### DESCRIPTION OF EXEMPLARY EMBODIMENTS

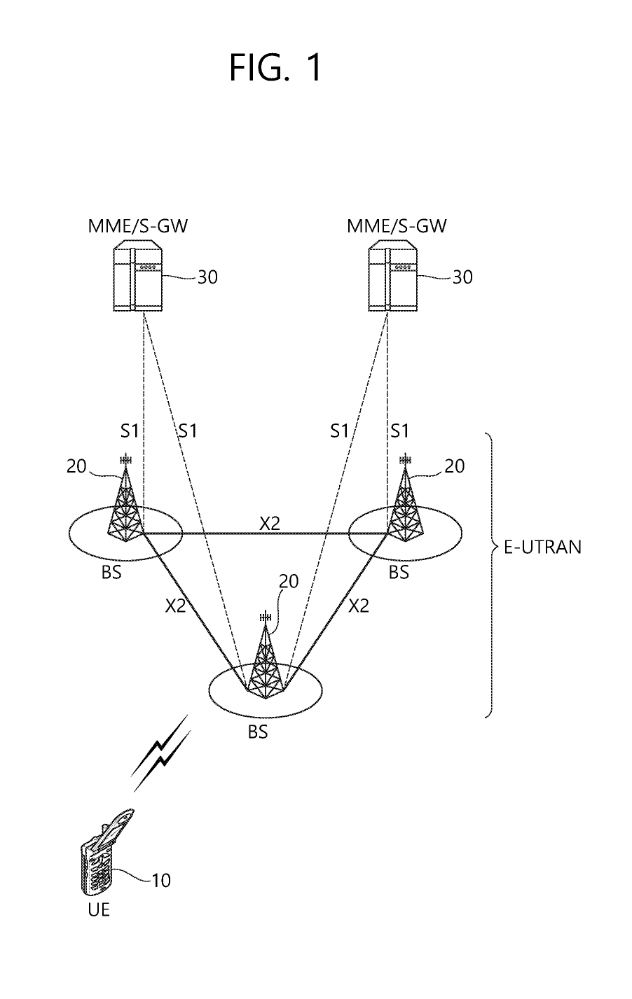

FIG. 1 shows a wireless communication system to which the present invention is applied. The wireless communication system may also be referred to as an evolved-UMTS terrestrial radio access network (E-UTRAN) or a long term evolution (LTE)/LTE-A system.

The E-UTRAN includes at least one base station (BS) 20 which provides a control plane and a user plane to a user equipment (UE) 10. The UE 10 may be fixed or mobile, and may be referred to as another terminology, such as a mobile station (MS), a user terminal (UT), a subscriber station (SS), a mobile terminal (MT), a wireless device, etc. The BS 20 is generally a fixed station that communicates with the UE 10 and may be referred to as another terminology, such as an evolved node-B (eNB), a base transceiver system (BTS), an access point, etc.

The BSs 20 are interconnected by means of an X2 interface. The BSs 20 are also connected by means of an S1 interface to an evolved packet core (EPC) 30, more specifically, to a mobility management entity (MME) through S1-MME and to a serving gateway (S-GW) through S1-U.

The EPC 30 includes an MME, an S-GW, and a packet data network-gateway (P-GW). The MME has access information of the UE or capability information of the UE, and such information is generally used for mobility management of the UE. The S-GW is a gateway having an E-UTRAN as an end point. The P-GW is a gateway having a PDN as an end point.

Layers of a radio interface protocol between the UE and the network can be classified into a first layer (L1), a second layer (L2), and a third layer (L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

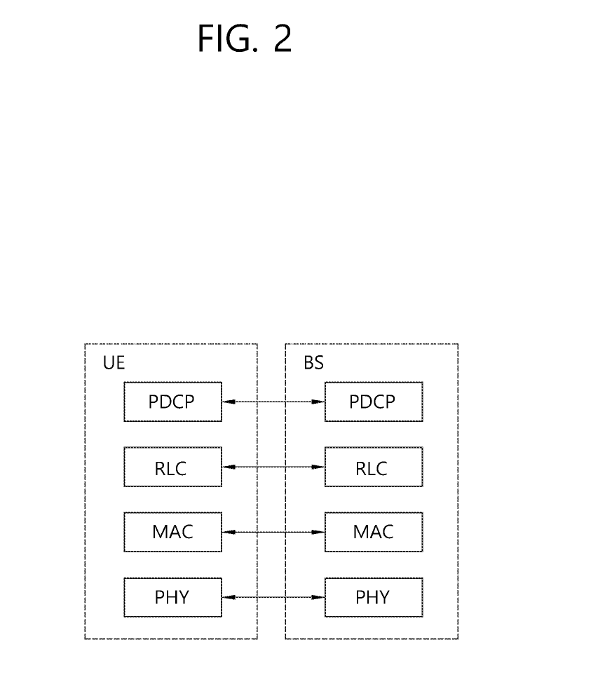

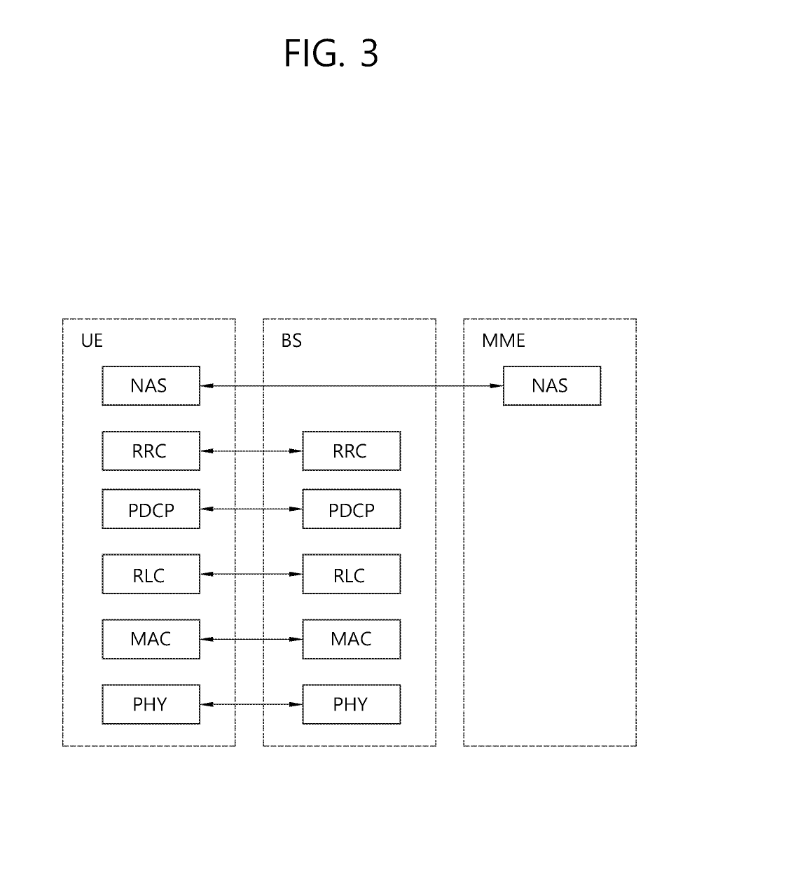

FIG. 2 is a diagram showing a wireless protocol architecture for a user plane. FIG. 3 is a diagram showing a wireless protocol architecture for a control plane. The user plane is a protocol stack for user data transmission. The control plane is a protocol stack for control signal transmission.

Referring to FIGS. 2 and 3, a PHY layer provides an upper layer with an information transfer service through a physical channel. The PHY layer is connected to a medium access control (MAC) layer which is an upper layer of the PHY layer through a transport channel. Data is transferred between the MAC layer and the PHY layer through the transport channel. The transport channel is classified according to how and with what characteristics data is transferred through a radio interface.

Data is moved between different PHY layers, that is, the PHY layers of a transmitter and a receiver, through a physical channel. The physical channel may be modulated according to an Orthogonal Frequency Division Multiplexing (OFDM) scheme, and use the time and frequency as radio resources.

The functions of the MAC layer include mapping between a logical channel and a transport channel and multiplexing and demultiplexing to a transport block that is provided through a physical channel on the transport channel of a MAC Service Data Unit (SDU) that belongs to a logical channel. The MAC layer provides service to a Radio Link Control (RLC) layer through the logical channel.

The functions of the RLC layer include the concatenation, segmentation, and reassembly of an RLC SDU. In order to guarantee various types of Quality of Service (QoS) required by a Radio Bearer (RB), the RLC layer provides three types of operation mode: Transparent Mode (TM), Unacknowledged Mode (UM), and Acknowledged Mode (AM). AM RLC provides error correction through an Automatic Repeat Request (ARQ).

The RRC layer is defined only on the control plane. The RRC layer is related to the configuration, reconfiguration, and release of radio bearers, and is responsible for control of logical channels, transport channels, and PHY channels. An RB means a logical route that is provided by the first layer (PHY layer) and the second layers (MAC layer, the RLC layer, and the PDCP layer) in order to transfer data between UE and a network.

The function of a Packet Data Convergence Protocol (PDCP) layer on the user plane includes the transfer of user data and header compression and ciphering. The function of the PDCP layer on the user plane further includes the transfer and encryption/integrity protection of control plane data.

What an RB is configured means a process of defining the characteristics of a wireless protocol layer and channels in order to provide specific service and configuring each detailed parameter and operating method. An RB can be divided into two types of a Signaling RB (SRB) and a Data RB (DRB). The SRB is used as a passage through which an RRC message is transmitted on the control plane, and the DRB is used as a passage through which user data is transmitted on the user plane.

If RRC connection is established between the RRC layer of UE and the RRC layer of an E-UTRAN, the UE is in the RRC connected state. If not, the UE is in the RRC idle state.

A downlink transport channel through which data is transmitted from a network to UE includes a broadcast channel (BCH) through which system information is transmitted and a downlink shared channel (SCH) through which user traffic or control messages are transmitted. Traffic or a control message for downlink multicast or broadcast service may be transmitted through the downlink SCH, or may be transmitted through an additional downlink multicast channel (MCH). Meanwhile, an uplink transport channel through which data is transmitted from UE to a network includes a random access channel (RACH) through which an initial control message is transmitted and an uplink shared channel (SCH) through which user traffic or control messages are transmitted.

Logical channels that are placed over the transport channel and that are mapped to the transport channel include a broadcast control channel (BCCH), a paging control channel (PCCH), a common control channel (CCCH), a multicast control channel (MCCH), and a multicast traffic channel (MTCH).

The physical channel includes several OFDM symbols in the time domain and several subcarriers in the frequency domain. One subframe includes a plurality of OFDM symbols in the time domain. An RB is a resources allocation unit, and includes a plurality of OFDM symbols and a plurality of subcarriers. Furthermore, each subframe may use specific subcarriers of specific OFDM symbols (e.g., the first OFDM symbol) of the corresponding subframe for a physical downlink control channel (PDCCH), that is, an L1/L2 control channel. A Transmission Time Interval (TTI) is a unit time for subframe transmission.

The RRC state of UE and an RRC connection method are described below.

The RRC state means whether or not the RRC layer of UE is logically connected to the RRC layer of the E-UTRAN. A case where the RRC layer of UE is logically connected to the RRC layer of the E-UTRAN is referred to as an RRC connected state. A case where the RRC layer of UE is not logically connected to the RRC layer of the E-UTRAN is referred to as an RRC idle state. The E-UTRAN may check the existence of corresponding UE in the RRC connected state in each cell because the UE has RRC connection, so the UE may be effectively controlled. In contrast, the E-UTRAN is unable to check UE in the RRC idle state, and a Core Network (CN) manages UE in the RRC idle state in each tracking area, that is, the unit of an area greater than a cell. That is, the existence or non-existence of UE in the RRC idle state is checked only for each large area. Accordingly, the UE needs to shift to the RRC connected state in order to be provided with common mobile communication service, such as voice or data.

When a user first powers UE, the UE first searches for a proper cell and remains in the RRC idle state in the corresponding cell. The UE in the RRC idle state establishes RRC connection with an E-UTRAN through an RRC connection procedure when it is necessary to set up the RRC connection, and shifts to the RRC connected state. A case where UE in the RRC idle state needs to set up RRC connection includes several cases. For example, the cases may include a need to send uplink data for a reason, such as a call attempt by a user, and to send a response message as a response to a paging message received from an E-UTRAN.

A Non-Access Stratum (NAS) layer placed over the RRC layer performs functions, such as session management and mobility management.

In the NAS layer, in order to manage the mobility of UE, two types of states: EPS Mobility Management-REGISTERED (EMM-REGISTERED) and EMM-DEREGISTERED are defined. The two states are applied to UE and the MME. UE is initially in the EMM-DEREGISTERED state. In order to access a network, the UE performs a process of registering it with the corresponding network through an initial attach procedure. If the attach procedure is successfully performed, the UE and the MME become the EMM-REGISTERED state.

In order to manage signaling connection between UE and the EPC, two types of states: an EPS Connection Management (ECM)-IDLE state and an ECM-CONNECTED state are defined. The two states are applied to UE and the MME. When the UE in the ECM-IDLE state establishes RRC connection with the E-UTRAN, the UE becomes the ECM-CONNECTED state. The MME in the ECM-IDLE state becomes the ECM-CONNECTED state when it establishes 51 connection with the E-UTRAN. When the UE is in the ECM-IDLE state, the E-UTRAN does not have information about the context of the UE. Accordingly, the UE in the ECM-IDLE state performs procedures related to UE-based mobility, such as cell selection or cell reselection, without a need to receive a command from a network. In contrast, when the UE is in the ECM-CONNECTED state, the mobility of the UE is managed in response to a command from a network. If the location of the UE in the ECM-IDLE state is different from a location known to the network, the UE informs the network of its corresponding location through a tracking area update procedure.

System information is described below.

System information includes essential information that needs to be known by UE in order for the UE to access a BS. Accordingly, the UE needs to have received all pieces of system information before accessing the BS, and needs to always have the up-to-date system information. Furthermore, the BS periodically transmits the system information because the system information is information that needs to be known by all UEs within one cell. The system information is divided into a Master Information Block (MIB) and a plurality of System Information Blocks (SIBs).

The MIB may include the limited number of parameters which are the most essential and are most frequently transmitted in order to obtain other information from a cell. UE first discovers an MIB after downlink synchronization. The MIB may include information, such as a downlink channel bandwidth, a PHICH configuration, an SFN supporting synchronization and operating as a timing reference, and an eNB transmission antenna configuration. The MIB may be broadcasted on a BCH.

SystemInformationBlockType1 (SIB1) of included SIBs is included in a “SystemInformationBlockType1” message and transmitted. Other SIBs other than the SIB1 are included in a system information message and transmitted. The mapping of the SIBs to the system information message may be flexibly configured by a scheduling information list parameter included in the SIB1. In this case, each SIB is included in a single system information message. Only SIBs having the same scheduling required value (e.g. period) may be mapped to the same system information message. Furthermore, SystemInformationBlockType2 (SIB2) is always mapped to a system information message corresponding to the first entry within the system information message list of a scheduling information list. A plurality of system information messages may be transmitted within the same period. The SIB1 and all of the system information messages are transmitted on a DL-SCH.

In addition to broadcast transmission, in the E-UTRAN, the SIB1 may be channel-dedicated signaling including a parameter set to have the same value as an existing set value. In this case, the SIB1 may be included in an RRC connection re-establishment message and transmitted.

The SIB1 includes information related to UE cell access and defines the scheduling of other SIBs. The SIB1 may include information related to the PLMN identifiers, Tracking Area Code (TAC), and cell ID of a network, a cell barring state indicative of whether a cell is a cell on which UE can camp, a required minimum reception level within a cell which is used as a cell reselection reference, and the transmission time and period of other SIBs.

The SIB2 may include radio resource configuration information common to all types of UE. The SIB2 may include information related to an uplink carrier frequency and uplink channel bandwidth, an RACH configuration, a page configuration, an uplink power control configuration, a sounding reference signal configuration, a PUCCH configuration supporting ACK/NACK transmission, and a PUSCH configuration.

UE may apply a procedure for obtaining system information and for detecting a change of system information to only a PCell. In an SCell, when the corresponding SCell is added, the E-UTRAN may provide all types of system information related to an RRC connection state operation through dedicated signaling. When system information related to a configured SCell is changed, the E-UTRAN may release a considered SCell and add the considered SCell later. This may be performed along with a single RRC connection re-establishment message. The E-UTRAN may set a value broadcast within a considered SCell and other parameter value through dedicated signaling.

UE needs to guarantee the validity of a specific type of system information. Such system information is called required system information. The required system information may be defined as follows.
If UE is in the RRC IDLE state: the UE needs to have the valid version of the MIB and the SIB1 in addition to the SIB2 to SIB8. This may comply with the support of a considered RAT.
If UE is in the RRC connection state: the UE needs to have the valid version of the MIB, SIB1, and SIB2.

In general, the validity of system information may be guaranteed up to a maximum of 3 hours after being obtained.

In general, service that is provided to UE by a network may be classified into three types as follows. Furthermore, the UE differently recognizes the type of cell depending on what service may be provided to the UE. In the following description, a service type is first described, and the type of cell is described.

1) Limited service: this service provides emergency calls and an Earthquake and Tsunami Warning System (ETWS), and may be provided by an acceptable cell.

2) Suitable service: this service means public service for common uses, and may be provided by a suitable cell (or a normal cell).

3) Operator service: this service means service for communication network operators. This cell may be used by only communication network operators, but may not be used by common users.

In relation to a service type provided by a cell, the type of cell may be classified as follows.

1) An acceptable cell: this cell is a cell from which UE may be provided with limited service. This cell is a cell that has not been barred from a viewpoint of corresponding UE and that satisfies the cell selection criterion of the UE.

2) A suitable cell: this cell is a cell from which UE may be provided with suitable service. This cell satisfies the conditions of an acceptable cell and also satisfies additional conditions. The additional conditions include that the suitable cell needs to belong to a Public Land Mobile Network (PLMN) to which corresponding UE may access and that the suitable cell is a cell on which the execution of a tracking area update procedure by the UE is not barred. If a corresponding cell is a CSG cell, the cell needs to be a cell to which UE may access as a member of the CSG.

3) A barred cell: this cell is a cell that broadcasts information indicative of a barred cell through system information.

4) A reserved cell: this cell is a cell that broadcasts information indicative of a reserved cell through system information.

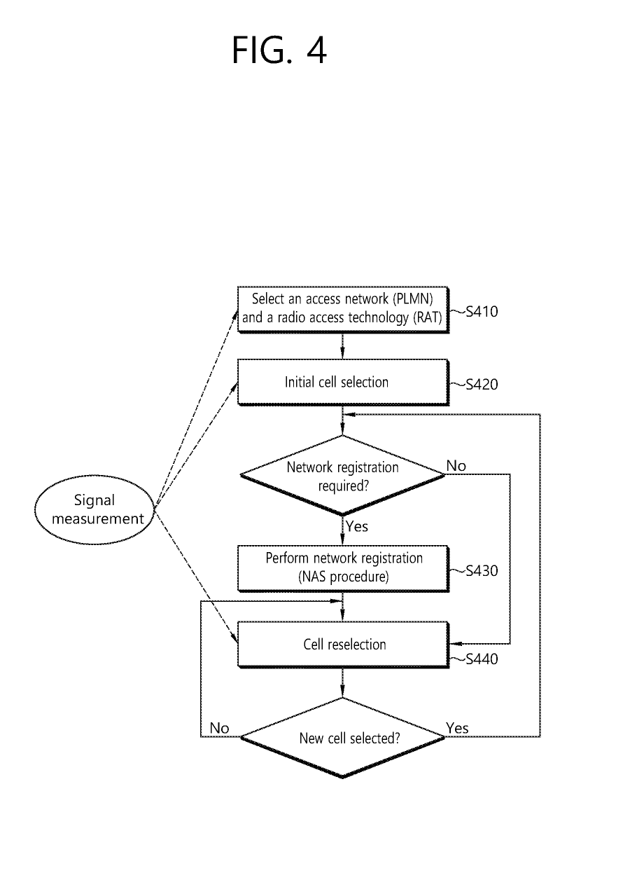

FIG. 4 is a flowchart illustrating the operation of UE in the RRC idle state. FIG. 4 illustrates a procedure in which UE that is initially powered on experiences a cell selection process, registers it with a network, and then performs cell reselection if necessary.

Referring to FIG. 4, the UE selects Radio Access Technology (RAT) in which the UE communicates with a Public Land Mobile Network (PLMN), that is, a network from which the UE is provided with service (S410). Information about the PLMN and the RAT may be selected by the user of the UE, and the information stored in a Universal Subscriber Identity Module (USIM) may be used.

The UE selects a cell that has the greatest value and that belongs to cells having measured BS and signal intensity or quality greater than a specific value (cell selection) (S420). In this case, the UE that is powered off performs cell selection, which may be called initial cell selection. A cell selection procedure is described later in detail. After the cell selection, the UE receives system information periodically by the BS. The specific value refers to a value that is defined in a system in order for the quality of a physical signal in data transmission/reception to be guaranteed. Accordingly, the specific value may differ depending on applied RAT.

If network registration is necessary, the UE performs a network registration procedure (S430). The UE registers its information (e.g., an IMSI) with the network in order to receive service (e.g., paging) from the network. The UE does not register it with a network whenever it selects a cell, but registers it with a network when information about the network (e.g., a Tracking Area Identity (TAI)) included in system information is different from information about the network that is known to the UE.

The UE performs cell reselection based on a service environment provided by the cell or the environment of the UE (S440). If the value of the intensity or quality of a signal measured based on a BS from which the UE is provided with service is lower than that measured based on a BS of a neighboring cell, the UE selects a cell that belongs to other cells and that provides better signal characteristics than the cell of the BS that is accessed by the UE. This process is called cell reselection differently from the initial cell selection of the No. 2 process. In this case, temporal restriction conditions are placed in order for a cell to be frequently reselected in response to a change of signal characteristic. A cell reselection procedure is described later in detail.

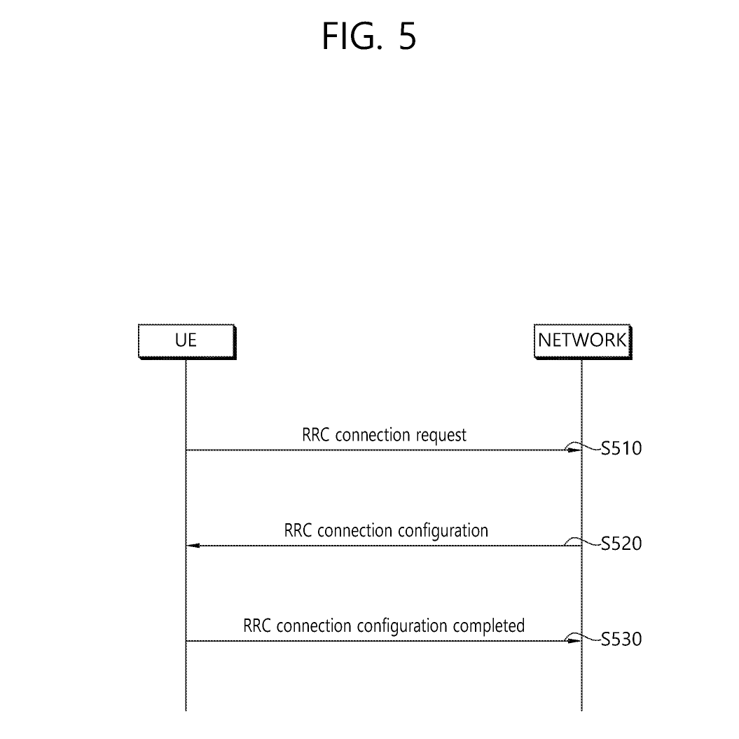

FIG. 5 is a flowchart illustrating a process of establishing RRC connection.

UE sends an RRC connection request message that requests RRC connection to a network (S510). The network sends an RRC connection establishment message as a response to the RRC connection request (S520). After receiving the RRC connection establishment message, the UE enters RRC connected mode.

The UE sends an RRC connection establishment complete message used to check the successful completion of the RRC connection to the network (S530).

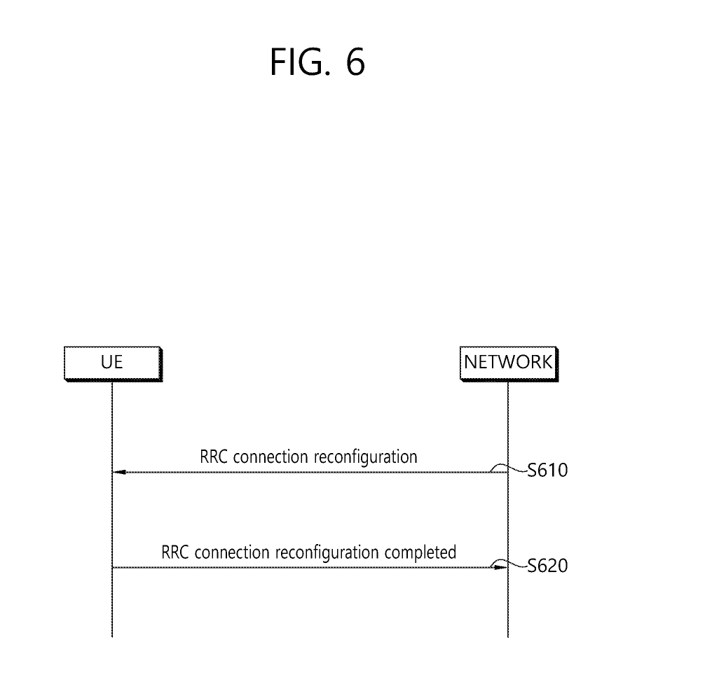

FIG. 6 is a flowchart illustrating an RRC connection reconfiguration process. An RRC connection reconfiguration is used to modify RRC connection. This is used to establish/modify/release RBs, perform handover, and set up/modify/release measurements.

A network sends an RRC connection reconfiguration message for modifying RRC connection to UE (S610). As a response to the RRC connection reconfiguration message, the UE sends an RRC connection reconfiguration complete message used to check the successful completion of the RRC connection reconfiguration to the network (S620).

Hereinafter, a public land mobile network (PLMN) is described.

The PLMN is a network which is disposed and operated by a mobile network operator. Each mobile network operator operates one or more PLMNs. Each PLMN may be identified by a Mobile Country Code (MCC) and a Mobile Network Code (MNC). PLMN information of a cell is included in system information and broadcasted.

In PLMN selection, cell selection, and cell reselection, various types of PLMNs may be considered by the terminal.

Home PLMN (HPLMN): PLMN having MCC and MNC matching with MCC and MNC of a terminal IMSI.

Equivalent HPLMN (EHPLMN): PLMN serving as an equivalent of an HPLMN.

Registered PLMN (RPLMN): PLMN successfully finishing location registration.

Equivalent PLMN (EPLMN): PLMN serving as an equivalent of an RPLMN.

Each mobile service consumer subscribes in the HPLMN. When a general service is provided to the terminal through the HPLMN or the EHPLMN, the terminal is not in a roaming state. Meanwhile, when the service is provided to the terminal through a PLMN except for the HPLMN/EHPLMN, the terminal is in the roaming state. In this case, the PLMN refers to a Visited PLMN (VPLMN).

When UE is initially powered on, the UE searches for available Public Land Mobile Networks (PLMNs) and selects a proper PLMN from which the UE is able to be provided with service. The PLMN is a network that is deployed or operated by a mobile network operator. Each mobile network operator operates one or more PLMNs. Each PLMN may be identified by Mobile Country Code (MCC) and Mobile Network Code (MNC).

Information about the PLMN of a cell is included in system information and broadcasted. The UE attempts to register it with the selected PLMN. If registration is successful, the selected PLMN becomes a Registered PLMN (RPLMN). The network may signalize a PLMN list to the UE. In this case, PLMNs included in the PLMN list may be considered to be PLMNs, such as RPLMNs. The UE registered with the network needs to be able to be always reachable by the network. If the UE is in the ECM-CONNECTED state (identically the RRC connection state), the network recognizes that the UE is being provided with service. If the UE is in the ECM-IDLE state (identically the RRC idle state), however, the situation of the UE is not valid in an eNB, but is stored in the MME. In such a case, only the MME is informed of the location of the UE in the ECM-IDLE state through the granularity of the list of Tracking Areas (TAs). A single TA is identified by a Tracking Area Identity (TAI) formed of the identifier of a PLMN to which the TA belongs and Tracking Area Code (TAC) that uniquely expresses the TA within the PLMN.

Thereafter, the UE selects a cell that belongs to cells provided by the selected PLMN and that has signal quality and characteristics on which the UE is able to be provided with proper service.

The following is a detailed description of a procedure of selecting a cell by a terminal.

When power is turned-on or the terminal is located in a cell, the terminal performs procedures for receiving a service by selecting/reselecting a suitable quality cell.

A terminal in an RRC idle state should prepare to receive a service through the cell by always selecting a suitable quality cell. For example, a terminal where power is turned-on just before should select the suitable quality cell to be registered in a network. If the terminal in an RRC connection state enters in an RRC idle state, the terminal should selects a cell for stay in the RRC idle state. In this way, a procedure of selecting a cell satisfying a certain condition by the terminal in order to be in a service idle state such as the RRC idle state refers to cell selection. Since the cell selection is performed in a state that a cell in the RRC idle state is not currently determined, it is important to select the cell as rapid as possible. Accordingly, if the cell provides a wireless signal quality of a predetermined level or greater, although the cell does not provide the best wireless signal quality, the cell may be selected during a cell selection procedure of the terminal.

A method and a procedure of selecting a cell by a terminal in a 3GPP LTE is described with reference to 3GPP TS 36.304 V8.5.0 (2009-03) “User Equipment (UE) procedures in idle mode (Release 8)”.

A cell selection process is basically divided into two types.

The first is an initial cell selection process. In this process, UE does not have preliminary information about a wireless channel. Accordingly, the UE searches for all wireless channels in order to find out a proper cell. The UE searches for the strongest cell in each channel. Thereafter, if the UE has only to search for a suitable cell that satisfies a cell selection criterion, the UE selects the corresponding cell.

Next, the UE may select the cell using stored information or using information broadcasted by the cell. Accordingly, cell selection may be fast compared to an initial cell selection process. If the UE has only to search for a cell that satisfies the cell selection criterion, the UE selects the corresponding cell. If a suitable cell that satisfies the cell selection criterion is not retrieved though such a process, the UE performs an initial cell selection process.

The cell selection criterion may be defined as below equation 1.

Srxlev>0 AND Squal>0 [Equation 1]

where:

Srxlev=Qᵣₓₗₑᵥₘₑₐₛ−(Qᵣₓₗₑᵥₘᵢₙ+Q_{rxlevminoffset})−Pcompensation

Squal=Q_{qualmeas}−(Q_{qualmin}+Q_{qualminoffset})

Here, the variables in the equation 1 may be defined as below table 1.

TABLE 1

| | |
|---|---|
| Srxlev | Cell selection RX level value (dB) |
| Squal | Cell selection quality value (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm) |
| Q_{qualmin} | Minimum required quality level in the cell (dB) |
| Q_{rxlevminoffset} | Offset to the signalled Qᵣₓₗₑᵥₘᵢₙ taken into account in the |
| | Srxlev evaluation as a result of a periodic search for a |
| | higher priority PLMN while camped normally in a |
| | VPLMN |
| Q_{qualminoffset} | Offset to the signalled Q_{qualmin} taken into account in the |
| | Squal evaluation as a result of a periodic search for a |
| | higher priority PLMN while camped normally in a |
| | VPLMN |
| Pcompensation | max(P_{EMAX} − P_{PowerClass}, 0) (dB) |
| P_{EMAX} | Maximum TX power level an UE may use when |
| | transmitting on the uplink in the cell (dBm) defined as |
| | P_{EMAX} in [TS 36.101] |
| P_{PowerClass} | Maximum RF output power of the UE (dBm) according |
| | to the UE power class as defined in [TS 36.101] |

Signalled values, i.e., Q_{rxlevminoffset} and Q_{qualminoffset}, may be applied to a case where cell selection is evaluated as a result of periodic search for a higher priority PLMN during a UE camps on a normal cell in a VPLMN. During the periodic search for the higher priority PLMN as described above, the UE may perform the cell selection evaluation by using parameter values stored in other cells of the higher priority PLMN.

After the UE selects a specific cell through the cell selection process, the intensity or quality of a signal between the UE and a BS may be changed due to a change in the mobility or wireless environment of the UE. Accordingly, if the quality of the selected cell is deteriorated, the UE may select another cell that provides better quality. If a cell is reselected as described above, the UE selects a cell that provides better signal quality than the currently selected cell. Such a process is called cell reselection. In general, a basic object of the cell reselection process is to select a cell that provides UE with the best quality from a viewpoint of the quality of a radio signal.

In addition to the viewpoint of the quality of a radio signal, a network may determine priority corresponding to each frequency, and may inform the UE of the determined priorities. The UE that has received the priorities preferentially takes into consideration the priorities in a cell reselection process compared to a radio signal quality criterion.

As described above, there is a method of selecting or reselecting a cell according to the signal characteristics of a wireless environment. In selecting a cell for reselection when a cell is reselected, the following cell reselection methods may be present according to the RAT and frequency characteristics of the cell.
Intra-frequency cell reselection: UE reselects a cell having the same center frequency as that of RAT, such as a cell on which the UE camps on.
Inter-frequency cell reselection: UE reselects a cell having a different center frequency from that of RAT, such as a cell on which the UE camps on
Inter-RAT cell reselection: UE reselects a cell that uses RAT different from RAT on which the UE camps

The principle of a cell reselection process is as follows.

First, UE measures the quality of a serving cell and neighbor cells for cell reselection.

Second, cell reselection is performed based on a cell reselection criterion. The cell reselection criterion has the following characteristics in relation to the measurements of a serving cell and neighbor cells.

Intra-frequency cell reselection is basically based on ranking. Ranking is a task for defining a criterion value for evaluating cell reselection and numbering cells using criterion values according to the size of the criterion values. A cell having the best criterion is commonly called the best-ranked cell. The cell criterion value is based on the value of a corresponding cell measured by UE, and may be a value to which a frequency offset or cell offset has been applied, if necessary.

Inter-frequency cell reselection is based on frequency priority provided by a network. UE attempts to camp on a frequency having the highest frequency priority. A network may provide frequency priority that will be applied by UEs within a cell in common through broadcasting signaling, or may provide frequency-specific priority to each UE through UE-dedicated signaling. A cell reselection priority provided through broadcast signaling may refer to a common priority. A cell reselection priority for each terminal set by a network may refer to a dedicated priority. If receiving the dedicated priority, the terminal may receive a valid time associated with the dedicated priority together. If receiving the dedicated priority, the terminal starts a validity timer set as the received valid time together therewith. While the valid timer is operated, the terminal applies the dedicated priority in the RRC idle mode. If the valid timer is expired, the terminal discards the dedicated priority and again applies the common priority.

For the inter-frequency cell reselection, a network may provide UE with a parameter (e.g., a frequency-specific offset) used in cell reselection for each frequency.

For the intra-frequency cell reselection or the inter-frequency cell reselection, a network may provide UE with a Neighboring Cell List (NCL) used in cell reselection. The NCL includes a cell-specific parameter (e.g., a cell-specific offset) used in cell reselection.

For the intra-frequency or inter-frequency cell reselection, a network may provide UE with a cell reselection black list used in cell reselection. The UE does not perform cell reselection on a cell included in the black list.

Ranking performed in a cell reselection evaluation process is described below.

A ranking criterion used to apply priority to a cell is defined as in Equation 1.

Rs=Qmeas,s+Qhyst,Rn=Qmeas,s−Qoffset [Equation 2]

In this case, Rs is the ranking criterion of a serving cell, Rn is the ranking criterion of a neighbor cell, Qmeas,s is the quality value of the serving cell measured by UE, Qmeas,n is the quality value of the neighbor cell measured by UE, Qhyst is the hysteresis value for ranking, and Qoffset is an offset between the two cells.

In Intra-frequency, if UE receives an offset “Qoffsets,n” between a serving cell and a neighbor cell, Qoffset=Qoffsets,n. If UE does not Qoffsets,n, Qoffset=0.

In Inter-frequency, if UE receives an offset “Qoffsets,n” for a corresponding cell, Qoffset=Qoffsets,n+Qfrequency. If UE does not receive “Qoffsets,n”, Qoffset=Qfrequency.

If the ranking criterion Rs of a serving cell and the ranking criterion Rn of a neighbor cell are changed in a similar state, ranking priority is frequency changed as a result of the change, and UE may alternately reselect the twos. Qhyst is a parameter that gives hysteresis to cell reselection so that UE is prevented from to alternately reselecting two cells.

UE measures RS of a serving cell and Rn of a neighbor cell according to the above equation, considers a cell having the greatest ranking criterion value to be the best-ranked cell, and reselects the cell.

In accordance with the criterion, it may be checked that the quality of a cell is the most important criterion in cell reselection. If a reselected cell is not a suitable cell, UE excludes a corresponding frequency or a corresponding cell from the subject of cell reselection.

A Radio Link Failure (RLF) is described below.

UE continues to perform measurements in order to maintain the quality of a radio link with a serving cell from which the UE receives service. The UE determines whether or not communication is impossible in a current situation due to the deterioration of the quality of the radio link with the serving cell. If communication is almost impossible because the quality of the serving cell is too low, the UE determines the current situation to be an RLF.

If the RLF is determined, the UE abandons maintaining communication with the current serving cell, selects a new cell through cell selection (or cell reselection) procedure, and attempts RRC connection re-establishment with the new cell.

In the specification of 3GPP LTE, the following examples are taken as cases where normal communication is impossible.
A case where UE determines that there is a serious problem in the quality of a downlink communication link (a case where the quality of a PCell is determined to be low while performing RLM) based on the radio quality measured results of the PHY layer of the UE
A case where uplink transmission is problematic because a random access procedure continues to fail in the MAC sublayer.
A case where uplink transmission is problematic because uplink data transmission continues to fail in the RLC sublayer.
A case where handover is determined to have failed.
A case where a message received by UE does not pass through an integrity check.

An RRC connection re-establishment procedure is described in more detail below.

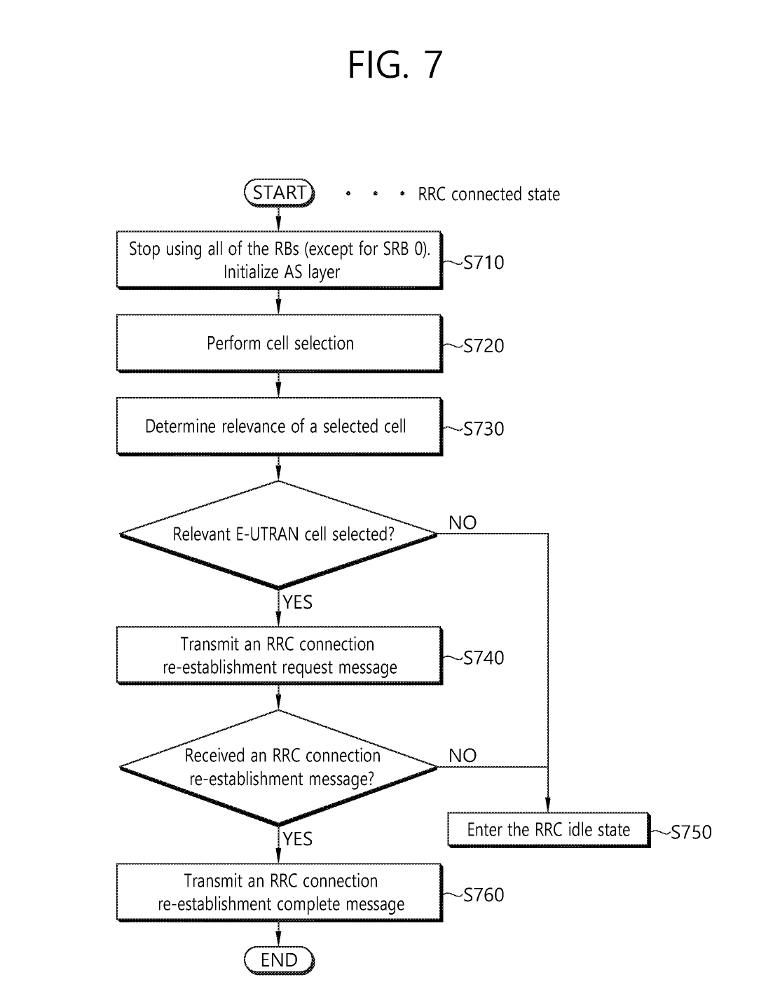

FIG. 7 is a diagram illustrating an RRC connection re-establishment procedure.

Referring to FIG. 7, UE stops using all the radio bearers that have been configured other than a Signaling Radio Bearer (SRB) #0, and initializes a variety of kinds of sublayers of an Access Stratum (AS) (S710). Furthermore, the UE configures each sublayer and the PHY layer as a default configuration. In this process, the UE maintains the RRC connection state.

The UE performs a cell selection procedure for performing an RRC connection reconfiguration procedure (S720). The cell selection procedure of the RRC connection re-establishment procedure may be performed in the same manner as the cell selection procedure that is performed by the UE in the RRC idle state, although the UE maintains the RRC connection state.

After performing the cell selection procedure, the UE determines whether or not a corresponding cell is a suitable cell by checking the system information of the corresponding cell (S730). If the selected cell is determined to be a suitable E-UTRAN cell, the UE sends an RRC connection re-establishment request message to the corresponding cell (S740).

Meanwhile, if the selected cell is determined to be a cell that uses RAT different from that of the E-UTRAN through the cell selection procedure for performing the RRC connection re-establishment procedure, the UE stops the RRC connection re-establishment procedure and enters the RRC idle state (S750).

The UE may be implemented to finish checking whether the selected cell is a suitable cell through the cell selection procedure and the reception of the system information of the selected cell. To this end, the UE may drive a timer when the RRC connection re-establishment procedure is started. The timer may be stopped if it is determined that the UE has selected a suitable cell. If the timer expires, the UE may consider that the RRC connection re-establishment procedure has failed, and may enter the RRC idle state. Such a timer is hereinafter called an RLF timer. In LTE spec TS 36.331, a timer named “T311” may be used as an RLF timer. The UE may obtain the set value of the timer from the system information of the serving cell.

If an RRC connection re-establishment request message is received from the UE and the request is accepted, a cell sends an RRC connection re-establishment message to the UE.

The UE that has received the RRC connection re-establishment message from the cell reconfigures a PDCP sublayer and an RLC sublayer with an SRB1. Furthermore, the UE calculates various key values related to security setting, and reconfigures a PDCP sublayer responsible for security as the newly calculated security key values. Accordingly, the SRB 1 between the UE and the cell is open, and the UE and the cell may exchange RRC control messages. The UE completes the restart of the SRB1, and sends an RRC connection re-establishment complete message indicative of that the RRC connection re-establishment procedure has been completed to the cell (S760).

In contrast, if the RRC connection re-establishment request message is received from the UE and the request is not accepted, the cell sends an RRC connection re-establishment reject message to the UE.

If the RRC connection re-establishment procedure is successfully performed, the cell and the UE perform an RRC connection reconfiguration procedure. Accordingly, the UE recovers the state prior to the execution of the RRC connection re-establishment procedure, and the continuity of service is guaranteed to the upmost.

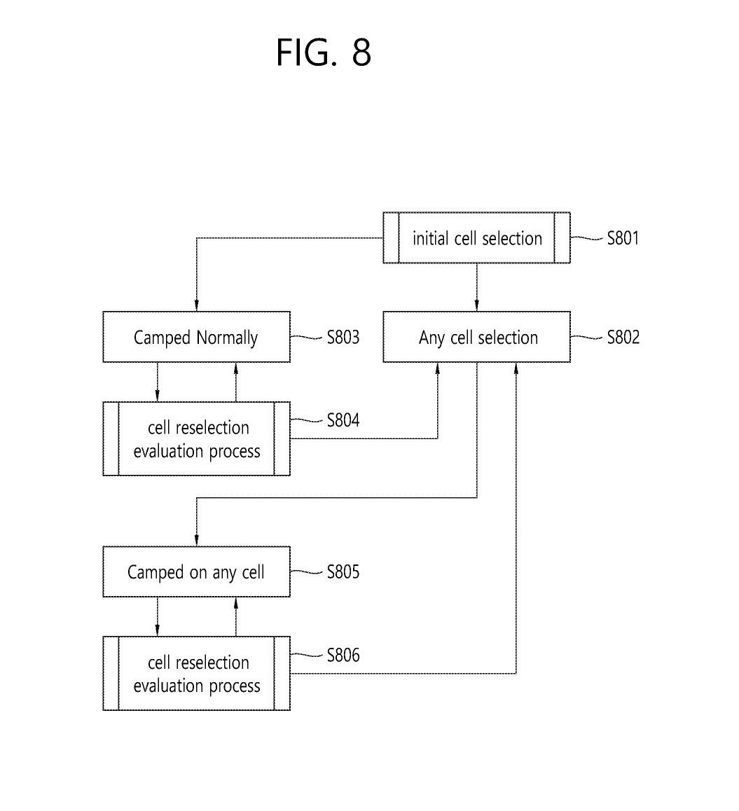

FIG. 8 illustrates substrates which may be owned by UE in the RRC IDLE state and a substrate transition process.

Referring to FIG. 8, UE performs an initial cell selection process (S801). The initial cell selection process may be performed when there is no cell information stored with respect to a PLMN or if a suitable cell is not discovered.

If a suitable cell is unable to be discovered in the initial cell selection process, the UE transits to any cell selection state (S802). The any cell selection state is the state in which the UE has not camped on a suitable cell and an acceptable cell and is the state in which the UE attempts to discover an acceptable cell of a specific PLMN on which the UE may camp. If the UE has not discovered any cell on which it may camp, the UE continues to stay in the any cell selection state until it discovers an acceptable cell.

If a suitable cell is discovered in the initial cell selection process, the UE transits to a normal camp state (S803). The normal camp state refers to the state in which the UE has camped on the suitable cell. In this state, the UE may select and monitor a paging channel based on information provided through system information and may perform an evaluation process for cell reselection.

If a cell reselection evaluation process (S804) is caused in the normal camp state (S803), the UE performs a cell reselection evaluation process (S804). If a suitable cell is discovered in the cell reselection evaluation process (S804), the UE transits to the normal camp state (S803) again.

If an acceptable cell is discovered in the any cell selection state (S802), the UE transmits to any cell camp state (S805). The any cell camp state is the state in which the UE has camped on the acceptable cell.

In the any cell camp state (S805), the UE may select and monitor a paging channel based on information provided through system information and may perform the evaluation process (S806) for cell reselection. If an acceptable cell is not discovered in the evaluation process (S806) for cell reselection, the UE transits to the any cell selection state (S802).

Now, a device-to-device (D2D) operation is described. In 3GPP LTE-A, a service related to the D2D operation is called a proximity service (ProSe). Now, the ProSe is described. Hereinafter, the ProSe is the same concept as the D2D operation, and the ProSe and the D2D operation may be used without distinction.

The ProSe includes ProSe direction communication and ProSe direct discovery. The ProSe direct communication is communication performed between two or more proximate UEs. The UEs may perform communication by using a protocol of a user plane. A ProSe-enabled UE implies a UE supporting a procedure related to a requirement of the ProSe. Unless otherwise specified, the ProSe-enabled UE includes both of a public safety UE and a non-public safety UE. The public safety UE is a UE supporting both of a function specified for a public safety and a ProSe procedure, and the non-public safety UE is a UE supporting the ProSe procedure and not supporting the function specified for the public safety.

ProSe direct discovery is a process for discovering another ProSe-enabled UE adjacent to ProSe-enabled UE. In this case, only the capabilities of the two types of ProSe-enabled UE are used. EPC-level ProSe discovery means a process for determining, by an EPC, whether the two types of ProSe-enabled UE are in proximity and notifying the two types of ProSe-enabled UE of the proximity.

Hereinafter, for convenience, the ProSe direct communication may be referred to as D2D communication, and the ProSe direct discovery may be referred to as D2D discovery.

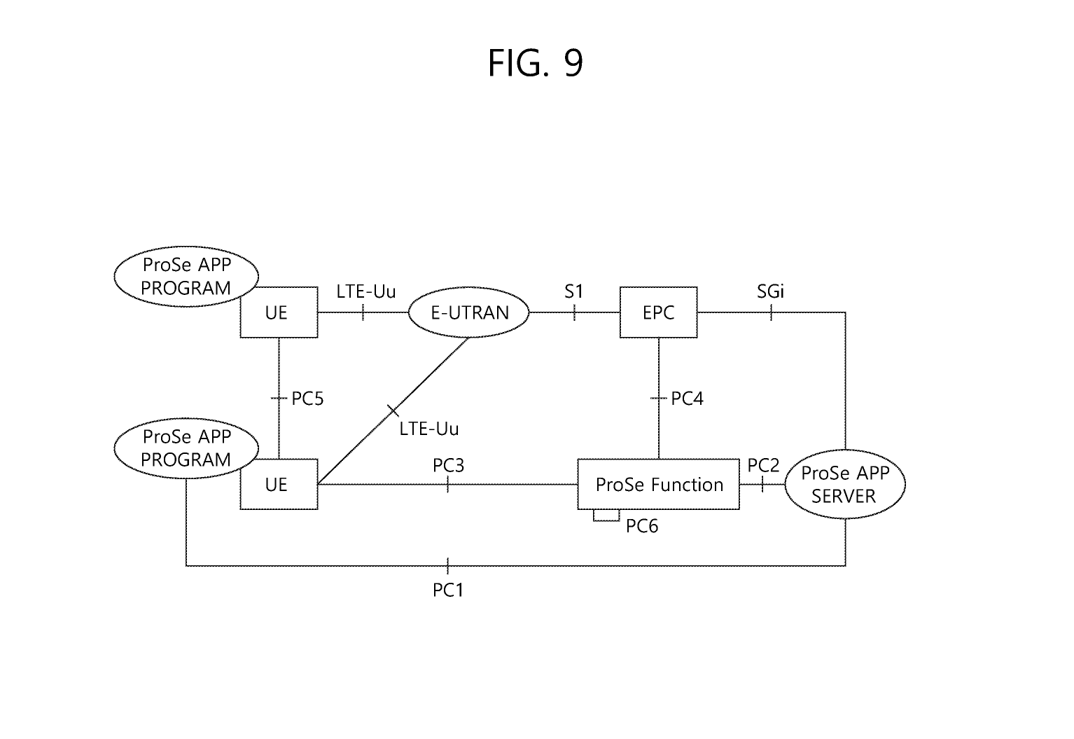

FIG. 9 shows a basic structure for ProSe.

Referring to FIG. 9, the basic structure for ProSe includes an E-UTRAN, an EPC, a plurality of types of UE including a ProSe application program, a ProSe application server (a ProSe APP server), and a ProSe function.

The EPC represents an E-UTRAN core network configuration. The EPC may include an MME, an S-GW, a P-GW, a policy and charging rules function (PCRF), a home subscriber server (HSS) and so on.

The ProSe APP server is a user of a ProSe capability for producing an application function. The ProSe APP server may communicate with an application program within UE. The application program within UE may use a ProSe capability for producing an application function.

The ProSe function may include at least one of the followings, but is not necessarily limited thereto.
Interworking via a reference point toward the 3rd party applications
Authorization and configuration of UE for discovery and direct communication
Enable the functionality of EPC level ProSe discovery
ProSe related new subscriber data and handling of data storage, and also handling of the ProSe identities
Security related functionality
Provide control towards the EPC for policy related functionality
Provide functionality for charging (via or outside of the EPC, e.g., offline charging)

A reference point and a reference interface in the basic structure for ProSe are described below.
PC1: a reference point between the ProSe application program within the UE and the ProSe application program within the ProSe APP server. This is used to define signaling requirements in an application dimension.
PC2: a reference point between the ProSe APP server and the ProSe function. This is used to define an interaction between the ProSe APP server and the ProSe function. The update of application data in the ProSe database of the ProSe function may be an example of the interaction.
PC3: a reference point between the UE and the ProSe function. This is used to define an interaction between the UE and the ProSe function. A configuration for ProSe discovery and communication may be an example of the interaction.
PC4: a reference point between the EPC and the ProSe function. This is used to define an interaction between the EPC and the ProSe function. The interaction may illustrate the time when a path for 1:1 communication between types of UE is set up or the time when ProSe service for real-time session management or mobility management is authenticated.
PC5: a reference point used for using control/user plane for discovery and communication, relay, and 1:1 communication between types of UE.
PC6: a reference point for using a function, such as ProSe discovery, between users belonging to different PLMNs.
SGi: this may be used to exchange application data and types of application dimension control information.

<ProSe Direct Communication>

ProSe direct communication is communication mode in which two types of public safety UE can perform direct communication through a PC 5 interface. Such communication mode may be supported when UE is supplied with services within coverage of an E-UTRAN or when UE deviates from coverage of an E-UTRAN.

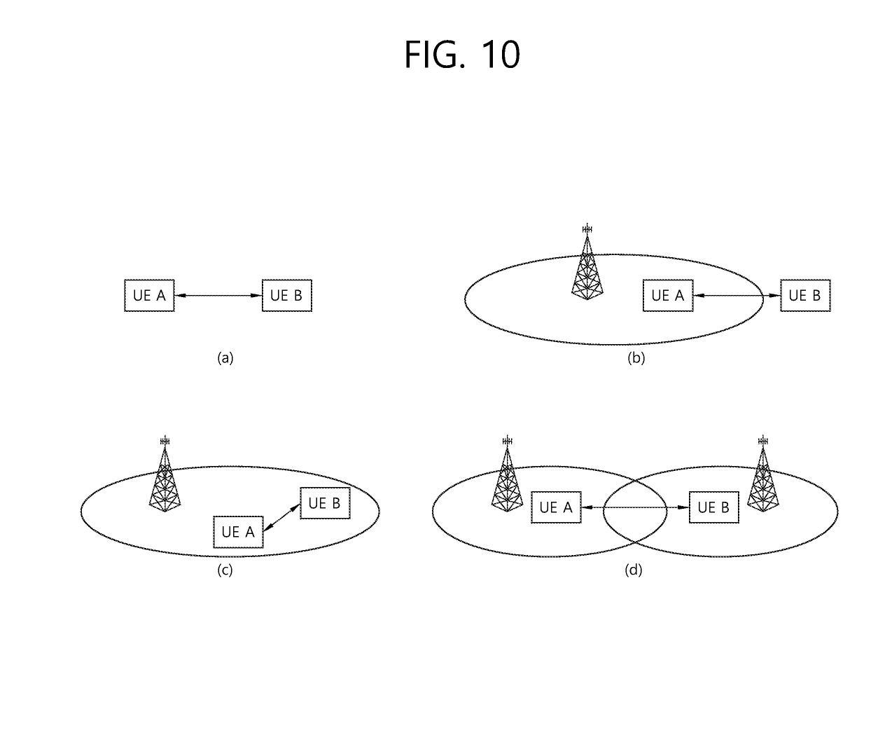

FIG. 10 shows the deployment examples of types of UE performing ProSe direct communication and cell coverage.

Referring to FIG. 10(a), types of UE A and B may be placed outside cell coverage. Referring to FIG. 10(b), UE A may be placed within cell coverage, and UE B may be placed outside cell coverage. Referring to FIG. 10(c), types of UE A and B may be placed within single cell coverage. Referring to FIG. 10(d), UE A may be placed within coverage of a first cell, and UE B may be placed within coverage of a second cell.

ProSe direct communication may be performed between types of UE placed at various positions as in FIG. 10.

Meanwhile, the following IDs may be used in ProSe direct communication.

A source layer-2 ID: this ID identifies the sender of a packet in the PC 5 interface.

A destination layer-2 ID: this ID identifies the target of a packet in the PC 5 interface.

An SA L1 ID: this ID is the ID of scheduling assignment (SA) in the PC 5 interface.

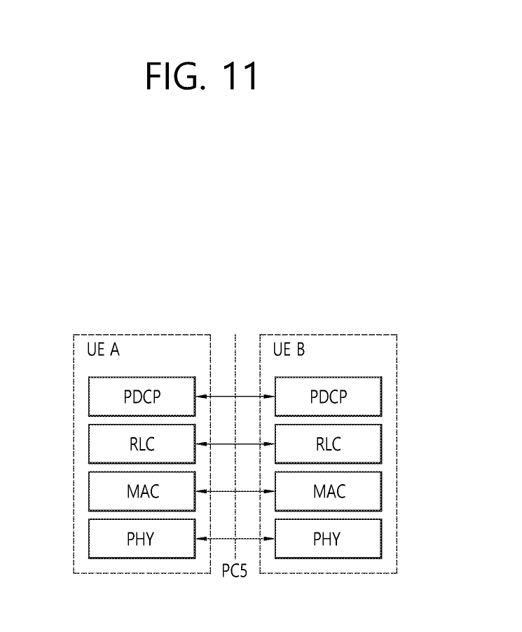

FIG. 11 shows a user plane protocol stack for ProSe direct communication.

Referring to FIG. 11, the PC 5 interface includes a PDCH, RLC, MAC, and PHY layers.

In ProSe direct communication, HARQ feedback may not be present. An MAC header may include a source layer-2 ID and a destination layer-2 ID.

<Radio Resource Assignment for ProSe Direct Communication>

ProSe-enabled UE may use the following two types of mode for resource assignment for ProSe direct communication.

1. Mode 1

Mode 1 is mode in which resources for ProSe direct communication are scheduled by an eNB. UE needs to be in the RRC_CONNECTED state in order to send data in accordance with mode 1. The UE requests a transmission resource from an eNB. The eNB performs scheduling assignment and schedules resources for sending data. The UE may send a scheduling request to the eNB and send a ProSe Buffer Status Report (BSR). The eNB has data to be subjected to ProSe direct communication by the UE based on the ProSe BSR and determines that a resource for transmission is required.

2. Mode 2

Mode 2 is mode in which UE directly selects a resource. UE directly selects a resource for ProSe direct communication in a resource pool. The resource pool may be configured by a network or may have been previously determined.

Meanwhile, if UE has a serving cell, that is, if the UE is in the RRC_CONNECTED state with an eNB or is placed in a specific cell in the RRC IDLE state, the UE is considered to be placed within coverage of the eNB.

If UE is placed outside coverage, only mode 2 may be applied. If the UE is placed within the coverage, the UE may use mode 1 or mode 2 depending on the configuration of an eNB.

If another exception condition is not present, only when an eNB performs a configuration, UE may change mode from mode 1 to mode 2 or from mode 2 to mode 1.

<ProSe Direct Discovery>

ProSe direct discovery refers to a procedure that is used for ProSe-enabled UE to discover another ProSe-enabled UE in proximity and is also called D2D direct discovery. In this case, E-UTRA radio signals through the PC 5 interface may be used. Information used in ProSe direct discovery is hereinafter called discovery information.

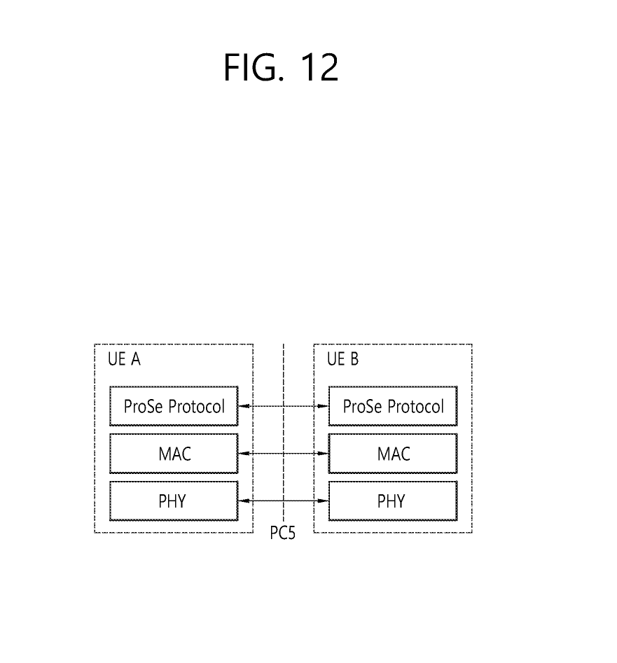

FIG. 12 shows the PC 5 interface for D2D direct discovery.

Referring to FIG. 12, the PC 5 interface includes an MAC layer, a PHY layer, and a ProSe Protocol layer, that is, a higher layer. The higher layer (the ProSe Protocol) handles the permission of the announcement and monitoring of discovery information. The contents of the discovery information are transparent to an access stratum (AS). The ProSe Protocol transfers only valid discovery information to the AS for announcement.

The MAC layer receives discovery information from the higher layer (the ProSe Protocol). An IP layer is not used to send discovery information. The MAC layer determines a resource used to announce discovery information received from the higher layer. The MAC layer produces an MAC protocol data unit (PDU) for carrying discovery information and sends the MAC PDU to the physical layer. An MAC header is not added.

In order to announce discovery information, there are two types of resource assignment.

1. Type 1

As a method in which resources for announcement of discovered information are allocated not specifically to a terminal, a base station provides a resource pool configuration for announcement of the discovered information to terminals. The configuration is included in a system information block (SIB) to be signaled by a broadcast scheme. Alternatively, the configuration may be provided while being included in a terminal specific RRC message. Alternatively, the configuration may be broadcast signaling of another layer except for an RRC message or terminal specific signaling.

The terminal autonomously selects the resource from an indicated resource pool and announces the discovery information by using the selected resource. The terminal may announce the discovery information through an arbitrarily selected resource during each discovery period.

2. Type 2

The type 2 is a method for assigning a resource for announcing discovery information in a UE-specific manner. UE in the RRC_CONNECTED state may request a resource for discovery signal announcement from an eNB through an RRC signal. The eNB may announce a resource for discovery signal announcement through an RRC signal. A resource for discovery signal monitoring may be assigned within a resource pool configured for types of UE.

An eNB 1) may announce a type 1 resource pool for discovery signal announcement to UE in the RRC IDLE state through the SIB. Types of UE whose ProSe direct discovery has been permitted use the type 1 resource pool for discovery information announcement in the RRC IDLE state. Alternatively, the eNB 2) announces that the eNB supports ProSe direct discovery through the SIB, but may not provide a resource for discovery information announcement. In this case, UE needs to enter the RRC_CONNECTED state for discovery information announcement.

An eNB may configure that UE has to use a type 1 resource pool for discovery information announcement or has to use a type 2 resource through an RRC signal in relation to UE in the RRC_CONNECTED state.

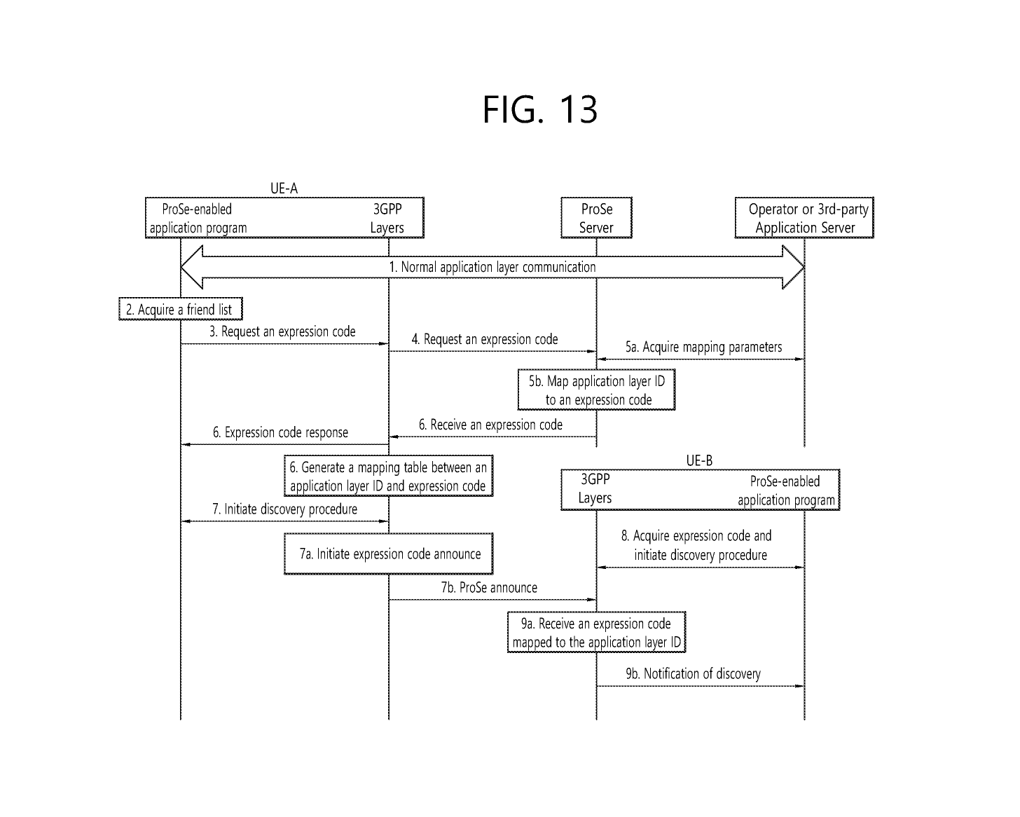

FIG. 13 is an embodiment of a ProSe discovery process.

Referring to FIG. 13, it is assumed that UE A and UE B have ProSe-enabled application programs managed therein and have been configured to have a ‘friend’ relation between them in the application programs, that is, a relationship in which D2D communication may be permitted between them. Hereinafter, the UE B may be represented as a ‘friend’ of the UE A. The application program may be, for example, a social networking program. ‘3GPP Layers’ correspond to the functions of an application program for using ProSe discovery service, which have been defined by 3GPP.

Direct discovery between the types of UE A and B may experience the following process.

1. First, the UE A performs regular application layer communication with the APP server. The communication is based on an Application Program Interface (API).

2. The ProSe-enabled application program of the UE A receives a list of application layer IDs having a ‘friend’ relation. In general, the application layer ID may have a network access ID form. For example, the application layer ID of the UE A may have a form, such as “adam@example.com.”

3. The UE A requests private expressions code for the user of the UE A and private representation code for a friend of the user.

4. The 3GPP layers send a representation code request to the ProSe server.

5. The ProSe server maps the application layer IDs, provided by an operator or a third party APP server, to the private representation code. For example, an application layer ID, such as adam@example.com, may be mapped to private representation code, such as “GTER543$#2FSJ67DFSF.” Such mapping may be performed based on parameters (e.g., a mapping algorithm, a key value and so on) received from the APP server of a network.

6. The ProSe server sends the types of derived representation code to the 3GPP layers. The 3GPP layers announce the successful reception of the types of representation code for the requested application layer ID to the ProSe-enabled application program. Furthermore, the 3GPP layers generate a mapping table between the application layer ID and the types of representation code.

7. The ProSe-enabled application program requests the 3GPP layers to start a discovery procedure. That is, the ProSe-enabled application program requests the 3GPP layers to start discovery when one of provided ‘friends’ is placed in proximity to the UE A and direct communication is possible. The 3GPP layers announces the private representation code (i.e., in the above example, “GTER543$#2FSJ67DFSF”, that is, the private representation code of adam@example.com) of the UE A. This is hereinafter called ‘announcement’. Mapping between the application layer ID of the corresponding application program and the private representation code may be known to only ‘friends’ which have previously received such a mapping relation, and the ‘friends’ may perform such mapping.

8. It is assumed that the UE B operates the same ProSe-enabled application program as the UE A and has executed the aforementioned 3 to 6 steps. The 3GPP layers placed in the UE B may execute ProSe discovery.

9. When the UE B receives the aforementioned ‘announce’ from the UE A, the UE B determines whether the private representation code included in the ‘announce’ is known to the UE B and whether the private representation code is mapped to the application layer ID. As described the 8 step, since the UE B has also executed the 3 to 6 steps, it is aware of the private representation code, mapping between the private representation code and the application layer ID, and corresponding application program of the UE A. Accordingly, the UE B may discover the UE A from the ‘announce’ of the UE A. The 3GPP layers announce that adam@example.com has been discovered to the ProSe-enabled application program within the UE B.

In FIG. 13, the discovery procedure has been described by taking into consideration all of the types of UE A and B, the ProSe server, the APP server and so on. From the viewpoint of the operation between the types of UE A and B, the UE A sends (this process may be called announcement) a signal called announcement, and the UE B receives the announce and discovers the UE A. That is, from the aspect that an operation that belongs to operations performed by types of UE and that is directly related to another UE is only step, the discovery process of FIG. 13 may also be called a single step discovery procedure.

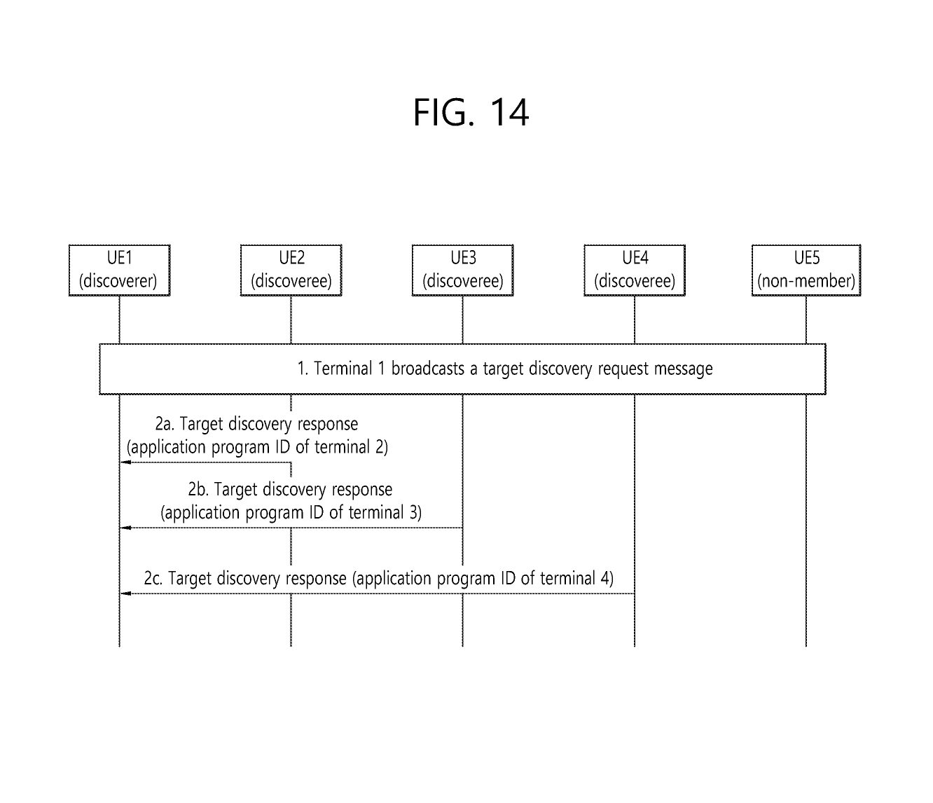

FIG. 14 is another embodiment of a ProSe discovery process.

In FIG. 14, types of UE 1 to 4 are assumed to types of UE included in specific group communication system enablers (GCSE) group. It is assumed that the UE 1 is a discoverer and the types of UE 2, 3, and 4 are discoveree. UE 5 is UE not related to the discovery process.

The UE 1 and the UE 2-4 may perform a next operation in the discovery process.

First, the UE 1 broadcasts a target discovery request message (may be hereinafter abbreviated as a discovery request message or M1) in order to discover whether specific UE included in the GCSE group is in proximity. The target discovery request message may include the unique application program group ID or layer-2 group ID of the specific GCSE group. Furthermore, the target discovery request message may include the unique ID, that is, application program private ID of the UE 1. The target discovery request message may be received by the types of UE 2, 3, 4, and 5.

The UE 5 sends no response message. In contrast, the types of UE 2, 3, and 4 included in the GCSE group send a target discovery response message (may be hereinafter abbreviated as a discovery response message or M2) as a response to the target discovery request message. The target discovery response message may include the unique application program private ID of UE sending the message.

An operation between types of UE in the ProSe discovery process described with reference to FIG. 14 is described below. The discoverer (the UE 1) sends a target discovery request message and receives a target discovery response message, that is, a response to the target discovery request message. Furthermore, when the discoveree (e.g., the UE 2) receives the target discovery request message, it sends a target discovery response message, that is, a response to the target discovery request message. Accordingly, each of the types of UE performs the operation of the 2 step. In this aspect, the ProSe discovery process of FIG. 14 may be called a 2-step discovery procedure.

In addition to the discovery procedure described in FIG. 14, if the UE 1 (the discoverer) sends a discovery conform message (may be hereinafter abbreviated as an M3), that is, a response to the target discovery response message, this may be called a 3-step discovery procedure.

In what follows, the operation assumed to be applied to a terminal according to the present invention is described.

<D2D Communication in the RRC Idle State>

A network can control whether to allow D2D transmission within a cell in the RRC idle state. A network can allow D2D transmission performed by a terminal in the RRC idle state within a specific cell, namely mode 2 D2D transmission. In this case, the network can inform the terminal about whether mode 2 D2D transmission is supported, for example, through broadcast system information of the specific cell. If the terminal fails to receive the system information, the terminal may regard the D2D transmission in the RRC idle state within the cell as being not allowed.

About D2D reception within a cell in the RRC idle state, as long as a network is allowed for D2D signal reception, it is not necessary for the network to control D2D signal reception of a terminal. In other words, the terminal can determine whether to receive a D2D signal. A terminal can receive a D2D signal irrespective of whether a specific cell supports D2D transmission in the RRC idle state.

<D2D Communication in the RRC Connected State>

When a terminal enters the RRC connected state, D2D transmission by the terminal is allowed under the condition that a valid D2D configuration can be applied in the RRC connected state. To this purpose, a network can provide a D2D configuration for a terminal through an RRC connection reconfiguration message including D2D configuration.

In other words, D2D transmission is allowed for a terminal in the RRC connected state only when a network provides a D2D configuration to the terminal. The D2D configuration can be provided to the terminal through a dedicated signal.

Now that the network has allowed the terminal to receive a D2D signal, the terminal can determine whether to receive a D2D signal in the RRC connected state. In other words, the terminal is capable of receiving a D2D signal irrespective of whether the terminal receives a D2D configuration through a dedicated signal.

<Mode Setup>

A network can configure a terminal in which mode the terminal can operate between mode 1 and 2 or in which mode the terminal has to operate between the two modes. Let the aforementioned configuration scheme be called mode configuration. At this time, signaling for mode configuration can use a upper layer signal such as RRC or a lower layer signal such as a physical layer signal. Since the mode configuration described above is not executed so often and is not sensitive to delay, an RRC signal can be used.

For those terminals in the RRC idle state, only the mode 2 can be applied. On the other hand, both of the mode 1 and 2 can be applied to a terminal in the RRC connected state. That is to say, selecting/configuring a terminal to one of the mode 1 or 2 is required only for the terminal in the RRC connected state. Therefore, dedicated RRC signaling can be used for mode configuration.

Meanwhile, in the mode configuration, available options are selecting one from the mode 1 and 2; or selecting one from the mode 1, mode 2, and mode 1&2. If mode 1&2 is selected, the network may schedule resources for D2D transmission upon the terminal's request, the terminal may execute D2D transmission by using the scheduled resources, or the terminal may execute D2D transmission by selecting specific resources from a resource pool.

The network can perform dedicated RRC signaling so that the terminal can be configured by one of the mode 1, mode 2, or mode 1&2.

<Resource Pool Configuration and Signaling>

With respect to D2D signal transmission of a terminal, in case a terminal configured to the mode 1 executes D2D transmission, resource scheduling for D2D transmission is performed for the terminal. Therefore, the terminal does not need to know the resource pool for D2D transmission. In case a terminal configured to the mode 2 performs D2D transmission, the terminal needs to know the resource pool for D2D transmission.

With respect to D2D signal reception of a terminal, in case a terminal attempts to receive D2D transmission performed by a different terminal in the mode 1, the terminal needs to know the mode 1 reception resource pool. At this time, the mode 1 reception resource pool can be a union of sets of resource pools used for D2D transmission performed by a serving cell and a neighboring cell in the mode 1. In case a terminal attempts to receive D2D transmission performed by another terminal in the mode 2, the terminal needs to know the mode 2 reception resource pool. At this time, the mode 2 reception resource pool can be a union of sets of resource pools used for D2D transmission performed by a serving cell and a neighboring cell in the mode 2.

In the resource pool of mode 1, a terminal does not need to know the mode 1 transmission resource pool. This is so because mode 1 D2D transmission is scheduled by a network. However, if a specific terminal attempts to receive mode 1 D2D transmission from a different terminal, the specific terminal needs to know the mode 1 transmission resource pool of the different terminal. In order for the specific terminal in the RRC idle state to receive mode 1 D2D transmission, it may be necessary for a cell to broadcast information informing of a mode 1 reception resource pool. This information can be applied both for the RRC idle state and the RRC connected state.

If a specific cell wants to allow a terminal belonging thereto mode 1 D2D reception, the specific cell can broadcast information informing of the mode 1 reception resource pool. The mode 1 reception resource pool information is available for a terminal in both of the RRC idle state and RRC connected state.

In order to allow/enable a terminal in the RRC idle state to perform mode 2 D2D transmission, the terminal needs to be informed of a resource pool available for the mode 2 D2D transmission while being in the RRC idle state. To this end, a cell can broadcast resource pool information. In other words, if a specific cell wants to allow D2D transmission for a terminal in the RRC idle state, resource pool information indicating a resource pool that can be applied for D2D transmission in the RRC idle state can be broadcast through system information.

In the same way, in order to allow/enable a terminal in the RRC idle state to perform mode 2 D2D reception, the terminal needs to be informed of a resource pool for mode 2 D2D reception. To this purpose, a cell can broadcast reception resource pool information indicating a reception resource pool.

In other words, if a specific cell wants to allow a terminal in the RRC idle state to perform D2D reception, the specific cell can broadcast resource pool information indicating a resource pool that can be applied for D2D reception in the RRC idle state through system information.

The resource pool information indicating a resource pool that can be applied for D2D transmission in the RRC idle state can also be applied for mode 2 D2D transmission in the RRC connected state. If a network configures mode 2 operation to a specific terminal through dedicated signaling, a resource pool which is the same as the resource pool broadcast can be provided. Or the broadcast resource pool can be considered as being applicable both for D2D transmission and D2D reception in the RRC connected state. The broadcast resource pool can be regarded as valid in the RRC connected state as long as a terminal is configured to the mode 2. In other words, unless a different resource is specified by dedicated signaling, broadcast mode 2 D2D resource pool information can also be used for mode 2 D2D communication in the RRC connected state.

A dedicated signal does not necessarily have to be used for informing a specific terminal within network coverage about resource pool information. In case the resource pool information is informed through dedicated signaling, optimization can be achieved by reducing monitoring resources for the specific terminal. However, the optimization may require complicated network cooperation among cells.

In what follows, the present invention will be described.

A terminal is capable of supporting existing cellular communication (namely communication between a terminal and a network, which can be called normal operation) and D2D operation simultaneously in the same frequency band according to the terminal's capability. Similarly, a terminal may be capable of supporting existing normal operation and D2D operation simultaneously in the same frequency band or in different frequency bands according to the terminal's capability. In other words, according to a terminal's capability, the terminal can support normal operation and D2D operation simultaneously in the same frequency band and in different frequency bands.

A terminal signals information indicating the terminal's capability to a network, which is called UE capability information. Meanwhile, since UE capability information according to the existing standard specifications informs only of the frequency band in which a terminal supports normal operation, namely operation according to cellular communication, a network is unable to know in which frequency band the terminal supports D2D operation or in which frequency band (or a combination of frequency bands) the terminal supports both of the normal operation and D2D operation. In what follows, a frequency band can be called simply a band. Also, in the following, EUTRA is assumed as a network in the cellular communication, but the present invention is not limited to the aforementioned assumption. Unless otherwise indicated, D2D operation includes D2D communication and D2D discovery; and includes transmission and reception.

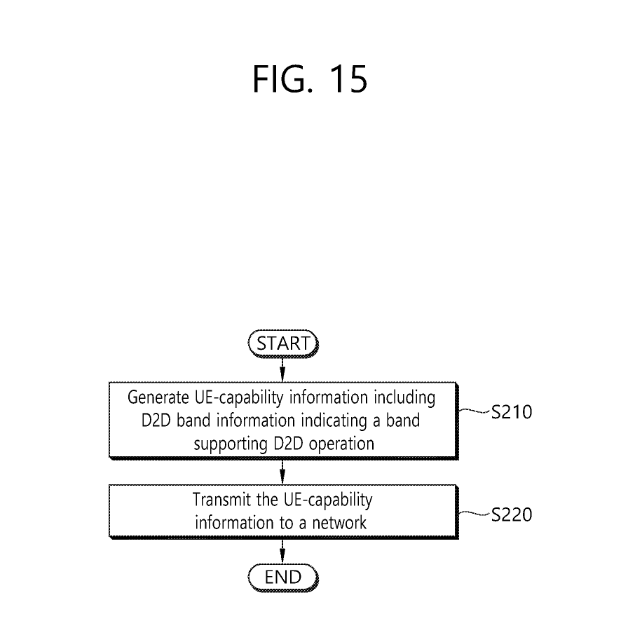

FIG. 15 illustrates a method for a terminal to perform D2D operation according to one embodiment of the present invention.

With reference to FIG. 15, a terminal generates UE-capability information including D2D band information indicating a frequency band in which D2D operation is supported S210 and transmits the UE-capability information to a network S220.

In other words, in order to inform in which frequency band or in which band combination (BC) normal operation and D2D operation are allowed, a terminal can inform the network of D2D band information indicating the bands (band combination) supporting D2D operation. D2D band information, being included in the UE-capability information, can be transmitted to the network.

The bands specified by D2D band information can be those bands in which a terminal is capable of supporting normal operation and D2D operation simultaneously. For example, while transmitting D2D band information including a list indicating the bands supporting D2D operation, a terminal can also transmit a list indicating the bands supporting normal operation. At this time, those bands indicated by both of the list indicating the bands supporting normal operation and the bands supporting D2D operation become the bands supporting both of the normal operation and the D2D operation. Similarly, D2D band information may include a list which directly indicates the bands supporting the normal operation and the D2D operation simultaneously.

Meanwhile, in case the terminal supports carrier aggregation, the terminal can provide a list of bands supporting normal operation through carrier aggregation and a list of bands supporting D2D operation through carrier aggregation (two different lists for the bands supporting normal operation through carrier aggregation and the bands supporting D2D operation through carrier aggregation can be provided; or the two lists can be combined to be provided as a single list). Each frequency band of the list or each combination of frequency bands represents a frequency band supporting normal operation and D2D operation simultaneously. In what follows, for the sake of convenience, if a terminal is said to merely support a band X, it is assumed to indicate that the terminal supports the existing cellular communication (normal operation) over the band X; if a terminal support D2D operation over the band X, it will be particularly noted.

Suppose a terminal supports band A, B, and C and is capable of supporting carrier aggregation (CA) employing two downlink bands and one uplink band. In case carrier aggregation has not been configured for the terminal, if those bands supported by the terminal is expressed in the form of a list, a list including {A}, {B}, and {C} will be obtained.

If carrier aggregation has been configured for the terminal, the terminal needs to inform the network about a combination of bands that the terminal supports from among various combinations of the bands A, B, and C. In the case of CA employing two downlink bands and one uplink band, various combinations as shown in the table below can be obtained.

TABLE 2

| Band combination | Meaning |
|---|---|
| {{A, B}, A} | Support downlink through band A, B and |
| | support uplink through band A |
| {{A, B}, B} | Support downlink through band A, B and |
| | support uplink through band B |
| {{A, B}, C} | Support downlink through band A, B and |
| | support uplink through band C |
| {{A, C}, A} | Support downlink through band A, C and |
| | support uplink through band A |
| {{A, C}, C} | Support downlink through band A, C and |
| | support uplink through band C |
| {{A, C}, B} | Support downlink through band A, C and |
| | support uplink through band B |
| {{B, C}, B} | Support downlink through band B, C and |
| | support uplink through band B |
| {{B, C}, C} | Support downlink through band B, C and |
| | support uplink through band C |
| {{B, C}, A} | Support downlink through band B, C and |
| | support uplink through band A |

If the terminal supports all of the band combinations shown in Table 2, the terminal needs to inform the network about all of the band combinations of Table 2 and can transmit a list including all of the band combinations to the network.

Meanwhile, if the terminal also supports D2D operation, it may be necessary for the terminal to inform the network of the bands supporting the D2D operation in addition to the band combinations supporting bands/carrier aggregation that the terminal supports.

First, in case a terminal does not support carrier aggregation or is not configured for carrier aggregation but supports D2D operation only, a band supported by the terminal or a band supporting D2D operation can be indicated by using the method shown in the following table. Since carrier aggregation is not supported or has not been configured, D2D operation is supported through a single carrier (cell) rather than a plurality of carriers (cells).

TABLE 3

| Band combination | Meaning |
|---|---|
| {A, A(D2D)} | Support band A, support band A for D2D |
| | operation |
| {A, B(D2D)} | Support band A, support band B for D2D |
| | operation |
| {A, C(D2D)} | Support band A, support band C for D2D |
| | operation |
| {B, A(D2D)} | Support band B, support band A for D2D |
| | operation |
| {B, B(D2D)} | Support band B, support band B for D2D |
| | operation |
| {B, C(D2D)} | Support band B, support band C for D2D |
| | operation |
| {C, A(D2D)} | Support band C, support band A for D2D |
| | operation |
| {C, B(D2D)} | Support band C, support band B for D2D |
| | operation |
| {C, C(D2D)} | Support band C, support band C for D2D |
| | operation |

In case a terminal supports D2D operation through a plurality of bands (namely in case a terminal is capable of supporting D2D operation through a plurality of bands at the same time while the terminal is executing cellular communication through one band), bands supported by the terminal and bands supporting D2D operation can be specified as shown in the following table.

TABLE 4

| Band combination | Meaning |
|---|---|
| {A, {A(D2D), B(D2D)}} | Support band A, support band A and B for |
| | D2D operation |
| {A, {A(D2D), C(D2D)}} | Support band A, support band A and C for |
| | D2D operation |
| {A, {B(D2D), C(D2D)}} | Support band A, support band B and C for |
| | D2D operation |
| {A, {A(D2D), B(D2D), | Support band A, support band A, B, and C |
| C(D2D)}} | for D2D operation |
| {B, {A(D2D), B(D2D)}} | Support band B, support band A and B for |
| | D2D operation |
| {B, {A(D2D), C(D2D)}} | Support band B, support band A and C for |
| | D2D operation |
| {B, {B(D2D), C(D2D)}} | Support band B, support band B and C for |
| | D2D operation |
| {B, {A(D2D), B(D2D), | Support band B, support band A, B, and C |
| C(D2D)}} | for D2D operation |
| {C, {A(D2D), B(D2D)}} | Support band C, support band A and B for |
| | D2D operation |
| {C, {A(D2D), C(D2D)}} | Support band C, support band A and C for |
| | D2D operation |
| {C, {B(D2D), C(D2D)}} | Support band C, support band B and C for |
| | D2D operation |
| {C, (A(D2D), B(D2D), | Support band C, support band A, B, and C |
| C(D2D)}} | for D2D operation |

In case a terminal supports carrier aggregation, the terminal can inform of band combinations supporting D2D operation along with band combinations supporting carrier aggregation.

For example, in case a terminal supporting carrier aggregation is configured with carrier aggregation comprising two downlink bands and one uplink band, and the terminal supports D2D operation through a single band, the terminal can specify band combinations as shown in the following table.

TABLE 5

| Band combination | Meaning |
|---|---|
| {{A, B}, A, A(D2D)} | Support D2D operation in band A together |
| | with carrier aggregation supporting downlink |
| | through band A and B and supporting uplink |
| | through band A |
| {{A, B}, A, B(D2D)} | Support D2D operation in band B together |
| | with carrier aggregation supporting downlink |
| | through band A and B and supporting uplink |
| | through band A |
| {{A, B}, A, C(D2D)} | Support D2D operation in band C together |
| | with carrier aggregation supporting downlink |
| | through band A and B and supporting uplink |
| | through band B |
| {{A, B}, B, A(D2D)} | Support D2D operation in band A together |
| | with carrier aggregation supporting downlink |
| | through band A and B and supporting uplink |
| | through band B |
| {{A, B}, B, B(D2D)} | Support D2D operation in band B together |
| | with carrier aggregation supporting downlink |
| | through band A and B and supporting uplink |
| | through band A |
| {{A, B}, B, C(D2D)} | Support D2D operation in band C together |
| | with carrier aggregation supporting downlink |
| | through band A and B and supporting uplink |
| | through band B |
| {{A, C}, A, A(D2D)} | Support D2D operation in band A together |
| | with carrier aggregation supporting downlink |
| | through band A and C and supporting uplink |
| | through band A |
| {{A, C}, A, B(D2D)} | Support D2D operation in band B together |
| | with carrier aggregation supporting downlink |
| | through band A and C and supporting uplink |
| | through band A |
| {{A, C}, A, C(D2D)} | Support D2D operation in band C together |
| | with carrier aggregation supporting downlink |
| | through band A and C and supporting uplink |
| | through band A |
| {{A, C}, C, A(D2D)} | Support D2D operation in band A together |
| | with carrier aggregation supporting downlink |
| | through band A and C and supporting uplink |
| | through band C |
| {{A, C}, C, B(D2D)} | Support D2D operation in band B together |
| | with carrier aggregation supporting downlink |
| | through band A and C and supporting uplink |
| | through band C |
| {{A, C}, C, C(D2D)} | Support D2D operation in band C together |
| | with carrier aggregation supporting downlink |
| | through band A and C and supporting uplink |
| | through band C |
| {{B, C}, A, A(D2D)} | Support D2D operation in band A together |
| | with carrier aggregation supporting downlink |
| | through band B and C and supporting uplink |
| | through band A |
| {{B, C}, A, B(D2D)} | Support D2D operation in band B together |
| | with carrier aggregation supporting downlink |
| | through band B and C and supporting uplink |
| | through band A |
| {{B, C}, A, C(D2D)} | Support D2D operation in band C together |
| | with carrier aggregation supporting downlink |
| | through band B and C and supporting uplink |
| | through band A |
| {{B, C}, C, A(D2D)} | Support D2D operation in band A together |
| | with carrier aggregation supporting downlink |
| | through band B and C and supporting uplink |
| | through band C |
| {{B, C}, C, B(D2D)} | Support D2D operation in band B together |
| | with carrier aggregation supporting downlink |
| | through band B and C and supporting uplink |
| | through band C |
| {{B, C}, C, C(D2D)} | Support D2D operation in band C together |
| | with carrier aggregation supporting downlink |
| | through band B and C and supporting uplink |
| | through band C |

Meanwhile, in case a terminal supporting carrier aggregation is configured with carrier aggregation comprising two downlink bands and one uplink band, and the terminal supports D2D operation through a plurality of bands, the terminal can specify band combinations as shown in the following table.

TABLE 6

| Band combination | Meaning |
|---|---|
| {{A, B}, A, {A(D2D), | Support D2D operation in band A and B |
| B(D2D)}} | together with carrier aggregation supporting |
| | downlink through band A and B and |
| | supporting uplink through band A |
| {{A, B}, A, {A(D2D), | Support D2D operation in band A and C |
| C(D2D)}} | together with carrier aggregation supporting |
| | downlink through band A and B and |
| | supporting uplink through band A |
| {{A, B}, A, {B(D2D), | Support D2D operation in band B and C |
| C(D2D)}} | together with carrier aggregation supporting |
| | downlink through band A and B and |
| | supporting uplink through band A |
| {{A, B}, A, {A(D2D), | Support D2D operation in band A, B, and C |
| B(D2D), C(D2D)}} | together with carrier aggregation supporting |
| | downlink through band A and B and |
| | supporting uplink through band A |
| {{A, B}, B, {A(D2D), | Support D2D operation in band A and B |
| B(D2D)}} | together with carrier aggregation supporting |
| | downlink through band A and B and |
| | supporting uplink through band B |
| {{A, B}, B, {A(D2D), | Support D2D operation in band A and C |
| C(D2D)}} | together with carrier aggregation supporting |
| | downlink through band A and B and |
| | supporting uplink through band A |
| {{A, B}, B, {B(D2D), | Support D2D operation in band B and C |
| C(D2D)}} | together with carrier aggregation supporting |
| | downlink through band A and B and |
| | supporting uplink through band B |
| {{A, B}, B, {A(D2D), | Support D2D operation in band A, B, and C |
| B(D2D), C(D2D)}} | together with carrier aggregation supporting |
| | downlink through band A and B and |
| | supporting uplink through band A |
| {{A, C}, A, {A(D2D), | Support D2D operation in band A and B |
| B(D2D)}} | together with carrier aggregation supporting |
| | downlink through band A and C and |
| | supporting uplink through band A |
| {{A, C}, A, {A(D2D), | Support D2D operation in band A and C |
| C(D2D)}} | together with carrier aggregation supporting |
| | downlink through band A and C and |
| | supporting uplink through band A |
| {{A, C}, A, {B(D2D), | Support D2D operation in band B and C |
| C(D2D)}} | together with carrier aggregation supporting |
| | downlink through band A and C and |
| | supporting uplink through band A |
| {{A, C}, A, {A(D2D), | Support D2D operation in band A, B, and C |
| B(D2D), C(D2D)}} | together with carrier aggregation supporting |
| | downlink through band A and C and |
| | supporting uplink through band A |
| {{A, C}, C, {A(D2D), | Support D2D operation in band A and B |
| B(D2D)}} | together with carrier aggregation supporting |
| | downlink through band A and C and |
| | supporting uplink through band C |
| {{A, C}, C, {A(D2D), | Support D2D operation in band A and C |
| C(D2D)}} | together with carrier aggregation supporting |
| | downlink through band A and C and |
| | supporting uplink through band C |
| {{A, C}, C, {B(D2D), | Support D2D operation in band B and C |
| C(D2D)}} | together with carrier aggregation supporting |
| | downlink through band A and C and |
| | supporting uplink through band C |
| {{A, C}, C, {A(D2D), | Support D2D operation in band A, B and C |
| B(D2D), C(D2D)}} | together with carrier aggregation supporting |
| | downlink through band A and C and |
| | supporting uplink through band C |
| {{B, C}, A, {A(D2D), | Support D2D operation in band A and B |
| B(D2D)}} | together with carrier aggregation supporting |
| | downlink through band B and C and |
| | supporting uplink through band A |
| {{B, C}, A, {A(D2D), | Support D2D operation in band A and C |
| C(D2D)}} | together with carrier aggregation supporting |
| | downlink through band B and C and |
| | supporting uplink through band A |
| {{B, C}, A, {B(D2D), | Support D2D operation in band B and C |
| C(D2D)}} | together with carrier aggregation supporting |
| | downlink through band B and C and |
| | supporting uplink through band A |
| {{B, C}, A, {A(D2D), | Support D2D operation in band A, B, and C |
| B(D2D), C(D2D)}} | together with carrier aggregation supporting |
| | downlink through band B and C and |
| | supporting uplink through band A |
| {{B, C}, C, {A(D2D), | Support D2D operation in band A and B |
| B(D2D)}} | together with carrier aggregation supporting |
| | downlink through band B and C and |
| | supporting uplink through band C |
| {{B, C}, C, {A(D2D), | Support D2D operation in band A and C |
| C(D2D)}} | together with carrier aggregation supporting |
| | downlink through band B and C and |
| | supporting uplink through band C |
| {{B, C}, C, {B(D2D), | Support D2D operation in band B and C |
| C(D2D)}} | together with carrier aggregation supporting |
| | downlink through band B and C and |
| | supporting uplink through band C |
| {{B, C}, C {A(D2D), | Support D2D operation in band A, B, and C |
| B(D2D), C(D2D)}} | together with carrier aggregation supporting |
| | downlink through band B and C and |
| | supporting uplink through band C |

As described in Tables 3 to 6, a terminal informs the network of the bands supporting cellular communication together with the bands supporting D2D operation.

According to the present invention, one of the three methods below can be used for informing of the bands supporting D2D operation.

<Method 1-a>

When a terminal informs a network of a list of bands supporting cellular communication, namely normal operation, the terminal can indicate Yes/No about whether each band of the list supports D2D operation. This method is advantageous since signaling size required to specify information about a band supporting D2D operation can be reduced, but is incapable of indicating a band supporting only D2D operation while not supporting cellular communication.

<Method 1-b>

When a terminal informs a network of a list of bands supporting cellular communication, namely normal operation, the terminal informs the network of a separate list supporting D2D operation. This method is advantageous since it can indicate a band which does not support cellular communication but supports D2D operation only; however, this method requires relatively large signaling size compared to that required by the method 1-a.

<Method 1-c>

Taking advantages of the method 1-a and the method 1-b, when a terminal informs a network of a list of bands supporting cellular communication by using the method 1-a, the terminal indicates Yes/No about whether each band of the list supports D2D operation. In the presence of a band not supporting cellular communication but supporting D2D operation only, the terminal informs the network of the band by using a separate list according to the method 1-b additionally.

Meanwhile, D2D operation comprises D2D communication and D2D discovery. There are two methods for a terminal to inform the network of a band supporting each D2D operation, as described below.

<Method 2-a>

A terminal can inform the network of a band supporting D2D communication and a band supporting D2D discovery separately.

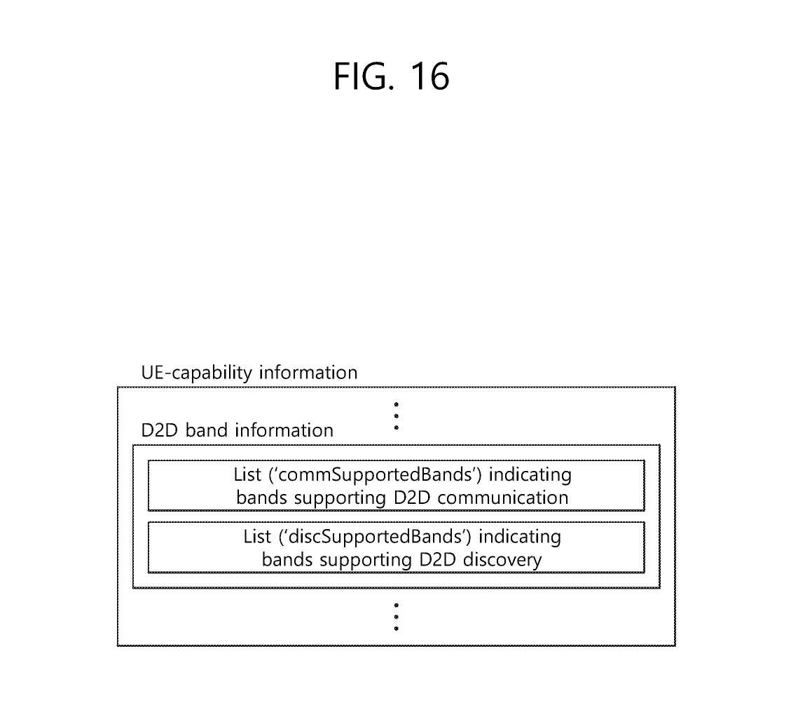

FIG. 16 illustrates UE-capability information including D2D band information according to the method 2-a.

With reference to FIG. 16, UE-capability information includes D2D band information, where the D2D band information includes a list indicating the bands supporting D2D communication (which is called ‘commSupportedBands’) and a list indicating the bands supporting D2D discovery (which is called ‘discSupportedBands’) separately.

For example, suppose a terminal supports D2D communication in the band J and D2D discovery operation in the band K. In this case, the terminal includes the band J in the list ‘commSupportedBands’ and the bank K in the discSupportedBands′.

<Method 2-b>

Different from the method 2-a, a terminal can inform the network of a band in which D2D operation is supported without differentiating between D2D communication and D2D discovery by using the method 2-b. For example, suppose a terminal supporting carrier aggregation comprising two downlink bands (band X and Y) and one uplink band (band X) supports D2D communication and D2D discovery operation simultaneously in the band J. In this case, the terminal includes the band J in the D2D band information, and the network receiving the D2D band information can interpret the received information that both of D2D communication and D2D discovery are supported in the band J. The UE-capability information delivers the information of {{downlink band X, downlink band Y}, uplink band X}, band J for D2D operation} to the network.

A terminal can deliver D2D band information to the network by using the method above. Meanwhile, taking into account the possibility that cellular communication (normal operation) and D2D operation can occur, a terminal may need to provide the information about whether the terminal supports simultaneous execution of normal operation and D2D operation to the network. If the terminal does not support simultaneous execution of normal and D2D operation, a base station may need to adjust scheduling of the normal operation or restrict the D2D operation so that the two operations are not performed simultaneously. If a terminal is capable of performing normal operation in the band A and D2D operation in the band B simultaneously while being capable of performing the normal operation in the band C but incapable of performing the D2D operation in the band B, a base station can perform a mobility procedure (for example, handover) so that the terminal can perform the normal operation in the band A. A terminal can use the following method to inform the network of the information about whether the terminal supports performing the normal operation and the D2D operation simultaneously.

<Method 3-a>

When a terminal informs a network of a list of bands or band combinations supporting normal operation, this method can be used to indicate whether each band in the list supports simultaneous execution of D2D operation (Yes/No).

A terminal can inform the network of UE-capability information about D2D operation by using only one from among the method 3-a and the type 1 methods (method 1-a, 1-b, and 1-c) or by using the method 3-a and one of type 1 methods separately. As one example of using only one from among the method 3-a and one of the type 1 methods, a terminal can adopt one of the method 3-a and the method 1-a. In this case, indicating that a terminal supports D2D operation in a particular band implies that the normal operation and the D2D operation can be performed simultaneously in the corresponding band. As one example of using the method 3-a and one of the type 1 methods separately, a terminal can use the method 2-a and the method 1-a separately. In this case, in addition to informing that a band supports D2D operation by using the method 1-a, the terminal can separately indicate whether the corresponding band supports simultaneous execution of the normal and the D2D operation by using the method 3-a.

<Method 3-b>

When a terminal informs a network of a list of bands/band combinations supporting cellular communication (normal operation), the terminal informs the network of information about D2D bands in which simultaneous execution of D2D operation is allowed for each entry of the list, namely for each band/band combination.

The information of D2D bands supporting simultaneous execution can be expressed in the form of a band list. Similarly, the information of D2D bands supporting simultaneous execution can be expressed in the form of a bitmap indicating whether a terminal supports simultaneous execution with respect to each band included in the list of bands supporting D2D operation. The number of bits of the bitmap can be the same as the number of bands indicated by the terminal by using one of the type 1 methods as supporting D2D operation.

As an example according to the method 3-b, a terminal can inform a network of the bands supporting D2D operation in the form of a list of D2D supporting bands, expressed as {A, B, C}, and the terminal can specify a bitmap of length 3 in addition to indicating a combination of the band A and the band B ({A, B}) as a combination supporting carrier aggregation. Each bit of the bitmap indicates whether the terminal supports the corresponding band of the list of D2D supporting bands. If the terminal indicates a band combination {A, B} indicated to support carrier aggregation by using a bitmap 100, this information can be interpreted that the terminal supports carrier aggregation operation employing the band combination of {A, B} and D2D operation in the band A simultaneously.

Similarly, if the terminal indicates a band combination {A, B} indicated to support carrier aggregation by using a bitmap 110, this information can be interpreted that the terminal supports simultaneous execution of carrier aggregation employing the band combination of {A, B} and D2D operation in the band A; and simultaneous execution of carrier aggregation employing the band combination of {A, B} and D2D operation in the band B.

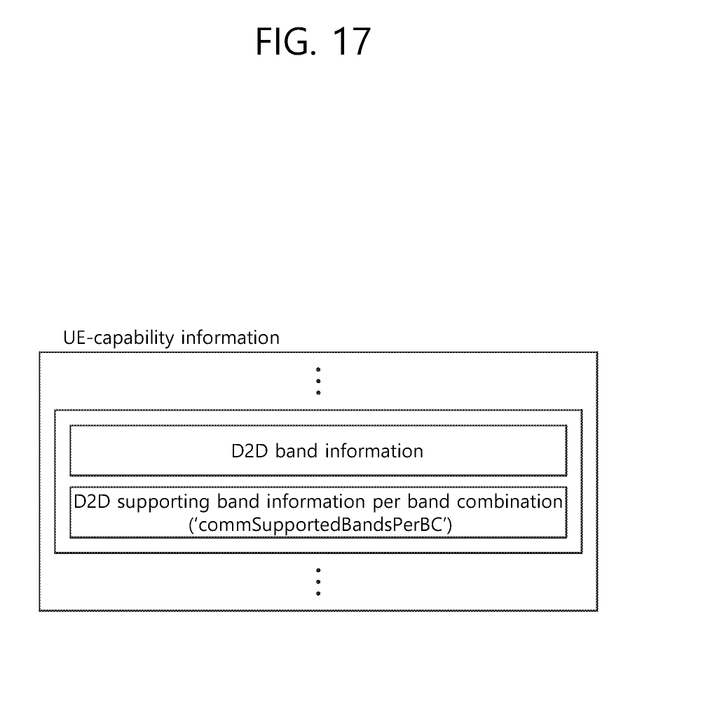

FIG. 17 illustrates another example of UE-capability information according to the present invention.

With reference to FIG. 17, UE-capability information can further include D2D supporting band information for each band combination (commSupportedBandPerBC) in addition to the D2D band information described with reference to FIGS. 15 and 16.

The D2D supporting band information per band combination can specify a frequency band in which a terminal supports cellular communication (normal operation) performed with respect to a network and D2D operation performed with respect to other terminals simultaneously in a band combination comprising two or more frequency bands for cellular communication.

For example, a terminal is capable of delivering information such as {{A, B}, A, A(D2D)} of Table 5 to a network, which informs the network that the terminal supports D2D operation in the band A along with carrier aggregation supporting downlink through the band A and B and uplink through the band A. At this time, it can be understood that the terminal indicates the band A as a frequency band supporting both cellular communication and D2D operation with respect to a band combination comprising the band A and B. In this case, the terminal can inform the network through D2D supporting band information per band combination that the band A supports cellular communication and D2D operation simultaneously in the band combination consisting of the band A and B.

The frequency band in which cellular communication performed with a network and D2D operation performed with other terminals are supported simultaneously can be included in a list of frequency bands supporting the D2D operation. The list can indicate one or more frequency bands.

A terminal can provide a bitmap being mapped to frequency bands included in a frequency band list consisting of one or more frequency bands supporting D2D operation. Through the bitmap, the terminal can indicate a frequency band which supports cellular communication performed by the terminal with the network and D2D operation performed by the terminal with other terminals simultaneously.

For example, if a particular bit of the bitmap is 1, it can imply that cellular communication and D2D operation are supported simultaneously in a frequency band mapped to the particular bit, which has been described earlier with respect to the method 3-b.

More specifically, the D2D supporting band information per band combination can specify the bands in which a terminal supports receiving a signal due to cellular communication (for example, a signal due to EUTRA) and a signal due to D2D communication simultaneously with respect to a particular band combination (BC).

If a terminal supports simultaneous transmission of signals due to EUTRA and D2D communication (a parameter indicating the simultaneous transmission is called ‘commSimultaneousTx’, and a terminal can inform of the simultaneous transmission through this parameter), the D2D supporting band information per band combination (′commSupportedBandPerBC) can also indicate the bands in which the terminal supports simultaneous transmission of signals due to EUTRA and D2D communication with respect to a specific band combination.

In other words, the D2D supporting band information per band combination indicates the bands (reception bands) supporting simultaneous reception of signals due to EUTRA and D2D communication; in case a terminal informs that it supports simultaneous transmission of signals due to EUTRA and D2D communication, it also indicates that the terminal supports simultaneous transmission of signals due to EUTRA and D2D communication in the reception bands.

The following table gives a specific example of UE-capability information described with reference to FIGS. 15 to 17.

```
TABLE 7
-- ASN1START
UE-EUTRA-Capability ::= SEQUENCE {
    accessStratumRelease AccessStratumRelease,
    ue-Category  INTEGER (1..5),
    pdcp-Parameters  PDCP-Parameters,
    phyLayerParameters  PhyLayerParameters,
    rf-Parameters  RF-Parameters,
    measParameters  MeasParameters,
    ...
    },
    nonCriticalExtension  UE-EUTRA-Capability-v920-IEs OPTIONAL
}
RF-Parameters ::= SEQUENCE {
    supportedBandListEUTRA SupportedBandListEUTRA
}
...
SupportedBandCombination-r10 ::= SEQUENCE (SIZE (1..maxBandComb-r10)) OF
BandCombinationParameters-r10
SupportedBandCombination-v12xy ::= SEQUENCE (SIZE (1..maxBandComb-r10)) OF
BandCombinationParameters-v12xy
...
BandCombinationParameters-v12xy ::= SEQUENCE {
    dc-Support-r12 SEQUENCE {
        supported-r12 SEQUENCE {
            asynchronous-r12 ENUMERATED {supported} OPTIONAL,
            supportedCellGrouping-r12 BIT STRING (SIZE (1..15))  OPTIONAL
        } OPTIONAL
    },
    supportedNAICS-2CRS-AP-r12 BIT STRING (SIZE (1..maxNAICS-Entries-r12)) OPTIONAL,
    commSupportedBandsPerBC-r12 BIT STRING (SIZE (1.. maxBands))  OPTIONAL,
    ...
}
...
Prose-Parameters-r12 ::=  SEQUENCE {
    commSimultaneousTx-r12  ENUMERATED {supported} OPTIONAL,
    commSupportedBands-r12 FreqBandIndicatorListEUTRA-r12 OPTIONAL,
    discSupportedBands-r12  ProseSupportedBandInfoList-r12  OPTIONAL,
    discScheduledResourceAlloc-r12  ENUMERATED {supported} OPTIONAL,
    disc-UE-SelectedResourceAlloc-r12  ENUMERATED {supported} OPTIONAL,
    disc-SLSS-r12  ENUMERATED {supported} OPTIONAL,
    discSupportedProc-r12 ENUMERATED {n50, n400}  OPTIONAL
}
ProseSupportedBandInfoList-r12 ::= SEQUENCE (SIZE (1..maxBands)) OF
ProseSupportedBandInfo-r12
ProseSupportedBandInfo-r12 ::= SEQUENCE {
    support-r12 ENUMERATED {supported} OPTIONAL
}
FreqBandIndicatorListEUTRA-r12 ::= SEQUENCE (SIZE (1..maxBands)) OF FreqBandIndicator-r11
```

With reference to Table 7, UE-capability information includes information of conventional UE-capability information such as UE category (‘ue-Category’), physical layer parameter (‘phyLayerParameters’), and radio frequency parameter (‘rf-parameters’). The radio frequency parameter includes ‘supportedBandListEUTRA’, which represents the bands supporting cellular communication (EUTRA bands).

Meanwhile, UE-capability information includes additional parameters according to the present invention. The additional parameters are related to D2D operation and includes the aforementioned D2D band information and D2D supporting band information per band combination.

The D2D band information can be ‘commSupportedBands’ and ‘discSupprtedBands’ of Table 7, for example.

‘commSupportedBands’ indicates the bands in which a terminal supports D2D communication. In case ‘commSupportedBands’ indicates a plurality of bands, the plurality of bands can be regarded to form a band combination. ‘commSupportedBands’ can be provided in the form of a bitmap. Each bit of the bitmap comprising ‘commSupportedBands’ can correspond to each band included in ‘supportedBandListEUTRA’. In other words, the first bit of the bitmap comprising ‘commSupportedBands’ can correspond to the first band included in the ‘supportedBandListEUTRA’. If the value of a particular bit in the bitmap forming the ‘commSupportedBands’ is 1, it can indicate that the corresponding band of ‘supportedBandListEUTRA’ supports D2D communication. On the other hand, ‘commSupportedBands’ may be provided as a list separately from ‘supportedBandListEUTRA’.

‘discSupportedBands’ indicates the bands in which a terminal supports D2D discovery. ‘discSupportedBands’ can be provided in the form of a list including bands supporting operations for D2D discovery.

In other words, as shown in Table 7 above, D2D band information can inform of a band in which a terminal supports D2D communication and of a band in which a terminal supports D2D discovery separately.

The D2D supporting band information per band combination can correspond to ‘commSupportedBandsPerBC’ in Table 7 above. ‘commSupportedBandsPerBC’ represents the bands in which a terminal supports simultaneous reception of signals due to EUTRA and D2D communication with respect to a particular band combination (BC). If a terminal supports simultaneous transmission of signals due to ETRA and D2D communication (′commSimultaneousTx′ can inform that simultaneous transmission is supported and will be described later), ‘commSupportedBandsPerBC’ also represents the bands in which a terminal supports simultaneous transmission of signals due to EUTRA and D2D communication with respect to a particular band combination. In other words, ‘commSupportedBandsPerBC’ by default represents the bands (reception bands) in which a terminal supports simultaneous reception of signals due to EUTRA and D2D communication; in case a terminal informs that it supports simultaneous transmission of signals sue to EUTRA and D2D communication, it can be interpreted that the terminal also supports simultaneous transmission of signals due to EUTRA and D2D communication in the reception bands.

In Table 7 above, ‘commSimultaneousTx’ informs whether a terminal supports simultaneous transmission of signals due to EUTRA and D2D communication in all of the bands belonging to a band combination in which the terminal is known to support D2D operation.

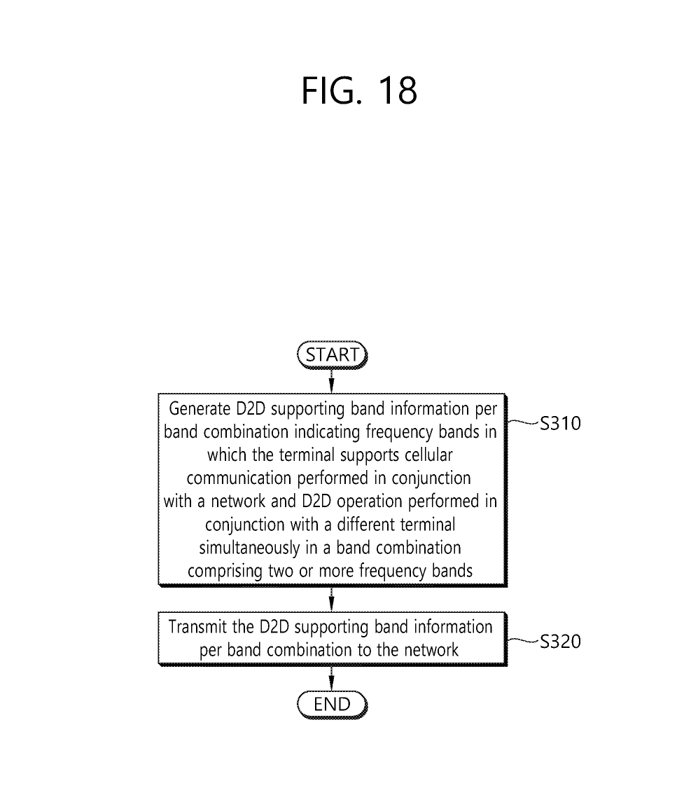

FIG. 18 illustrates a method for D2D operation according to another embodiment of the present invention.

With reference to FIG. 18, a terminal generates D2D supporting band information per band combination indicating a frequency band in which the terminal supports cellular communication performed with a network and D2D operation performed with another terminal simultaneously in a band combination comprising two or more frequency bands S310.

The terminal transmits the D2D supporting band information per band combination to the network S320.

Meanwhile, the terminal may further include additional information to the UE-capability information in addition to the D2D supporting band information per band combination.

For example, the terminal can inform of whether it supports full duplex operation between a band for D2D operation and a different band for cellular communication.

At this time, the full duplex operation indicates that between a signal band A for D2D operation and another band B for cellular operation, the terminal can receive a D2D signal transmitted by another terminal through the band A correctly while the terminal transmits a signal for cellular communication through the band B.

The terminal can inform a band supporting a full-duplex scheme for a cellular communication regarding a specific band supporting the D2D operation. That is, a corresponding band supporting a full-duplex scheme for a cellular communication for each D2D supporting band can be informed.

Alternatively, a terminal can inform the network of whether the full-duplex operation is supported with respect to a first band for D2D operation and a second band for D2D operation. At this time, the first and the second band are different from each other. For example, while a terminal transmits a signal for D2D communication over the band B and the terminal can be able to receive a signal for D2D communication transmitted from another terminal over the band A, it is considered that the terminal supports the full-duplex for D2D operation over the band A and B. In this case, the terminal can provide information informing that the terminal supports the full-duplex for D2D operation over the band A and B.

Alternatively, the terminal informs the network about a list indicating the bands where the terminal supports the full-duplex for D2D operation.

A terminal can inform the network of whether only the half-duplex operation is supported with respect to a band for D2D operation and a band for cellular communication. Here, half-duplex is an operating scheme that cellular communication is not supported in a band while D2D operation is performed in another band. And half-duplex is an operating scheme that D2D operation is not supported in a band while cellular communication is performed in another band.

For example, while a terminal transmits a signal for D2D communication over the band B, the terminal becomes unable to receive a signal due to cellular communication over the band A. This is so because a signal for D2D communication over the band B affects the receiver of the terminal tuned to the band A. The aforementioned phenomenon is also called self-interference. In other words, a terminal supporting only the half-duplex mode becomes unable to perform transmission of a signal over a particular band and reception of a signal over a different band simultaneously due to the self-interference.

Thus a terminal supporting only the half-duplex scheme also needs to inform of a band supporting the half-duplex scheme along with a band for cellular communication. In the example above, when a terminal informs a network of the band A, the terminal also needs to inform the network that it supports D2D operation according to the half-duplex scheme over the band B.

A terminal can inform the network of whether only the half-duplex operation is supported with respect to a first band for D2D operation and a second band for D2D operation. At this time, the first and the second band are different from each other.

For example, if a terminal is unable to receive a D2D communication signal transmitted by a different terminal over the band A while transmitting a signal for D2D communication over the band B, the terminal can be said to support only the half-duplex scheme for D2D operation over the band A and B. Since a signal for D2D communication transmitted by the terminal over the band B imposes a magnetic interference on the receiver of the terminal tuned to the band A, the terminal becomes unable to receive a D2D communication signal transmitted by a different terminal over the band A.

In this case, the terminal can provide the network with the information that the terminal supports full-duplex operation for D2D operation over the band A and B. In the example above, when the terminal informs the network of the band A in which the terminal supports D2D operation, the terminal can inform the network that it supports D2D operation over the band B only through half-duplex operation (it is equally the same that when the terminal informs the network of the band B in which the terminal supports D2D operation, the terminal can inform the network that it supports D2D operation over the band A only through half-duplex operation).

In the description above, it is assumed that a terminal explicitly specifies the duplex scheme that the terminal supports in the terminal's UE-capability information, but the present invention is not limited to the assumption above. In other words, a terminal may not explicitly specify the duplex scheme that the terminal supports in the terminal's UE-capability information.

As described above, in case information about a supported duplex scheme is not included explicitly in the UE-capability information, a network may consider that all of the band combinations informed of by a terminal support either full-duplex operation or half-duplex operation. For example, unless the UE-capability information indicates explicitly that a specific band combination supports only the half-duplex operation, the network can consider that except for the specific band combination, all of the remaining band combinations informed of by the terminal support full-duplex operation (conversely, unless the UE-capability information indicates explicitly that a specific band combination supports only the full-duplex operation, the network can consider that except for the specific band combination, all of the remaining band combinations informed of by the terminal support half-duplex operation).

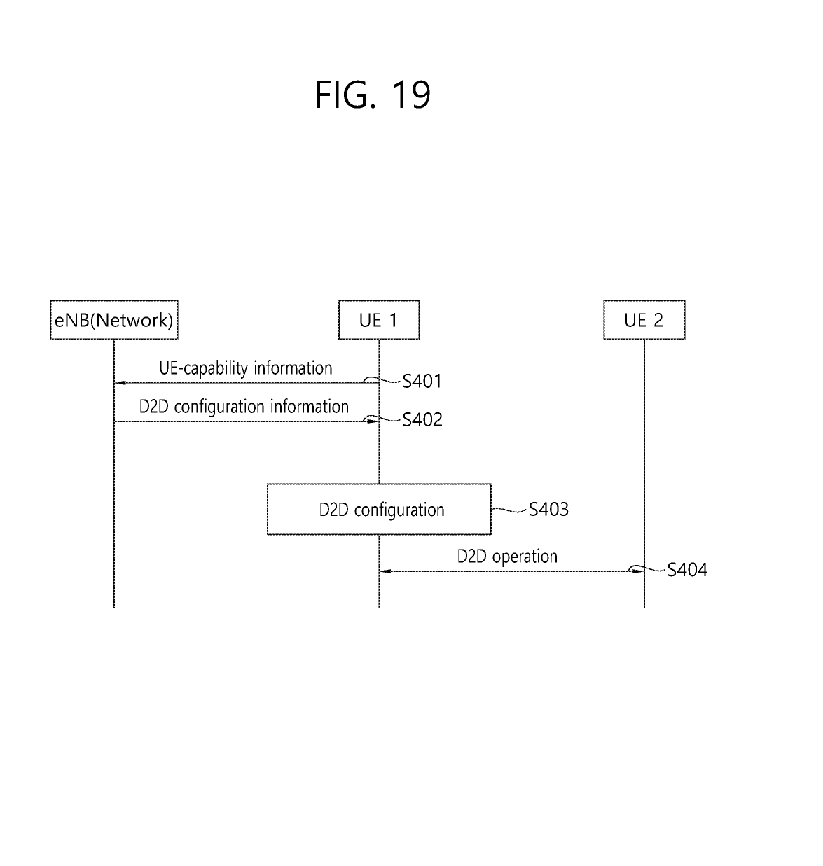

FIG. 19 illustrates a D2D operation method of a terminal according to the present invention.

With reference to FIG. 19, terminal 1 provides a network with UE-capability information S401. The UE-capability information can include the aforementioned D2D band information and D2D supporting band information per band combination.

The network provides the terminal 1 with D2D configuration information S402. Since the network can know the D2D band supported by the terminal 1 from the UE-capability information, it can configure an appropriate band for the terminal 1 to perform D2D operation. When the network provides D2D configuration information to the terminal 1, a procedure for moving a serving frequency of the terminal to another band (for example, handover or secondary cell replacement) may be performed according to the UE-capability information of the terminal.

The terminal 1 performs D2D configuration on the basis of the D2D configuration information S403.

The terminal 1 performs D2D operation in conjunction with terminal 2 S404. Although not shown in FIG. 19, terminal 2 can also exchange UE-capability information and D2D configuration information with the network before performing D2D operation.

In what follows, described will be a D2D operation method ensuring continuity of D2D operation even when a terminal supporting multiple RATs (Radio Access Technologies) performs a mobility procedure among RATs.

Depending on the capability of a terminal, D2D operation may or may not be possible while the terminal is receiving a service from a different RAT (Radio Access Technology) rather than E-UTRAN. In other words, suppose a terminal is receiving a service from a first RAT. Then the terminal may or may not be able to perform D2D operation when receiving a service from a second RAT. In this case, it is preferable that the terminal transmits UE-capability information describing the situation above to the network of the first RAT.

For example, suppose a terminal is operating in the E-UTRAN. Depending on the capability, the terminal can support performing D2D operation even while the terminal is receiving a service from the UTRAN. If the E-UTRAN is informed of the terminal's capability, the network can command the terminal to hand over to the UTRAN when communication quality of the E-UTRAN is not good enough. In spite of this operation, continuity of D2D operation of the terminal will not be influenced.

On the other hand, the terminal may not support performing D2D operation while receiving a service from the UTRAN. If the terminal informs the network of E-UTRAN of the aforementioned fact, the E-UTRAN may not command the terminal to hand over to the UTRAN even when communication quality of the E-UTRAN is not good enough. This is so because if the terminal hands over to the UTRAN, continuity of D2D operation may be broken.

In other words, suppose a terminal is receiving a service from the first RAT. The terminal may or may not be able to perform D2D operation when receiving a service from the second RAT. In this case, the terminal transmits UE-capability information informing the network of the first RAT of the aforementioned fact. By managing mobility of the terminal appropriately on the basis of the UE-capability information, the network based on the first RAT can support continuity of D2D operation.

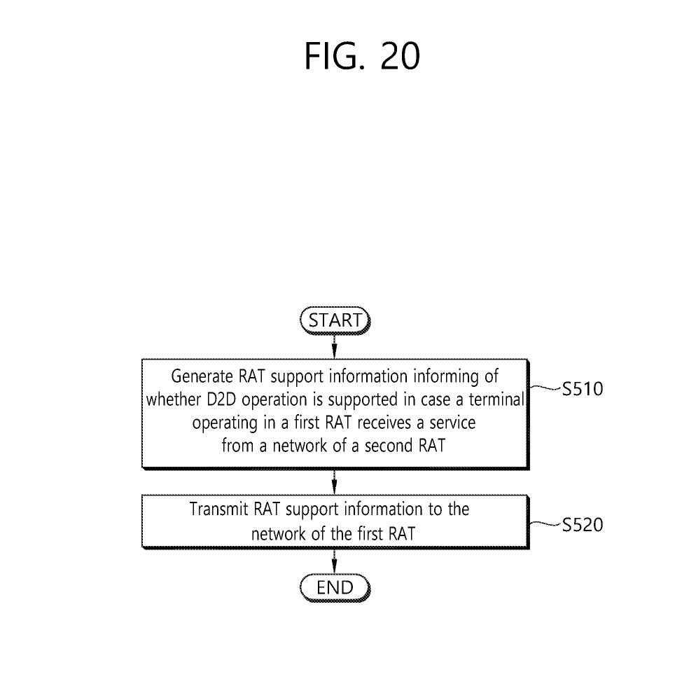

FIG. 20 illustrates a D2D operation method of a terminal according to one embodiment of the present invention.

With reference to FIG. 20, in case a terminal operating through a first RAT receives a service from a network of a second RAT, the terminal generates RAT support information informing of whether the terminal supports D2D operation S510.

The RAT support information can be transmitted being included in the UE-capability information of the terminal.

The UE-capability information can further include D2D band information indicating a frequency band or a combination of frequency bands in which the terminal supports D2D operation.

The D2D operation can be D2D communication.

The RAT support information can inform of whether the terminal supports D2D operation when the terminal receives a service from a network of the second RAT with respect to the frequency band or each of the frequency bands in which the terminal supports D2D operation.

The first RAT can be E-UTRAN (Evolved-UMTS Terrestrial Radio Access Network), the second RAT can be any one of UTRAN (UMTS Terrestrial Radio Access Network), GERAN (GSM EDGE radio access network), CDMA (Code Division Multiplexing Access) system, or WLAN (Wireless Local Area Network).

The terminal transmits RAT support information to the network of the first RAT S520.

In the method, the first RAT is one of UTRAN, GERAN, CDMA system, or WLAN, and the second RAT can also be applied to the case in which the network is based on the E-UTRAN.

In what follows, described will be an example of configuring UE-capability information including RAT support information, the UE-capability information being provided by the terminal.

The terminal can inform of whether each RAT supports D2D operation and cellular communication simultaneously. For example, suppose the terminal is operating according to the first RAT by default. The first RAT can be the E-UTRAN. At this time, the terminal, while receiving a service from the second RAT, for example, any one from among UTRAN, GERAN, CDMA system, and WLAN through UE-capability information (in other words, while performing cellular communication through the second RAT), can inform of whether the terminal also supports D2D operation through RAT support information.

To inform of whether the terminal supports cellular communication and D2D operation simultaneously over a particular frequency band among frequency bands based on the second RAT, the terminal can inform the network of the first RAT of the frequency band based on the second RAT in which the terminal is capable of supporting D2D operation and cellular communication simultaneously.

In case the terminal is capable of performing D2D operation through the second RAT in multiple frequency bands, the terminal can either inform of whether it is capable of supporting D2D operation and cellular communication simultaneously in the respective frequency bands or of frequency bands operating in the second RAT in which the terminal is capable of supporting D2D operation and cellular communication simultaneously.

To generalize the operation described above, the terminal can inform the network of a band combination consisting of a frequency band of the second RAT supporting D2D operation and a frequency band of the first RAT, where the combination of frequency bands indicates informing the network that the terminal is capable of supporting D2D operation in the frequency band of the second RAT and cellular communication in the frequency band of the first RAT.

On the other hand, the terminal can inform the network of whether the terminal supports D2D operation simultaneously while receiving a service from another RAT rather than the E-UTRAN through RAT support information. In the example above, RAT support information informs of whether the terminal supports D2D operation for each RAT; in the present example, however, instead of informing of whether the terminal supports D2D operation for each RAT, the RAT support information informs of only whether the terminal supports D2D operation while receiving a service from the network of different RAT rather than the E-UTRAN.

Or the terminal can inform the network of the second RAT of whether the terminal supports D2D operation through the network of the first RAT simultaneously while receiving a cellular communication service from the network of the second RAT. To inform that the terminal is capable of supporting D2D operation simultaneously in a particular frequency band among the frequency bands of the first RAT supported by the terminal, the terminal can inform of the frequency band of the first RAT in which the terminal is capable of simultaneous support. Since the second RAT frequency bands in which the terminal is capable of performing cellular operation are many for most cases, the terminal can inform of the frequency band of the first RAT in which the terminal is capable of simultaneous support with respect to the respective frequency bands of the second RAT that the terminal supports.

To generalize the operation described above, the terminal can inform the network of a band combination consisting of a frequency band of the first RAT supporting D2D operation and a frequency band of the second RAT, where the combination of frequency bands indicates informing the network that the terminal is capable of supporting D2D operation in the frequency band of the first RAT and cellular communication in the frequency band of the second RAT.

If the terminal attempts to perform or is already performing D2D operation through the first RAT while performing cellular operation in a cell of the second RAT, the terminal can transmit a message indicating intent to perform D2D operation to the cell of the second RAT. At this time, the terminal can elaborate on the D2D operation to perform. For example, the terminal can inform the cell of whether the terminal attempts to perform D2D transmission, D2D reception, or both. At this time, the terminal can inform the serving cell of the second RAT of the frequency of the first RAT by which the terminal intends to perform D2D operation. The terminal can inform the serving cell of the second RAT of the cell ID of the cell on which the D2D operation by the terminal is performed (for example, a cell of the first RAT which has received D2D configuration information).

In case the terminal changes a serving cell according to a mobility procedure such as handover from a cell of the first RAT to a cell of the second RAT, the terminal can transmit a message indicating intent to perform D2D operation or indicating that D2D operation is being performed to the cell of the second RAT. In case the terminal changes a serving cell according to a mobility procedure such as handover from a cell of the second RAT to a cell of the first RAT, the terminal can transmit a message indicating intent to perform D2D operation or indicating that D2D operation is being performed to the cell of the first RAT.

At the time of transmitting the UE-capability information, the terminal can additionally inform of whether the terminal supports full-duplex communication between D2D operation and cellular communication according to the corresponding RAT or supports only the half-duplex communication between them.

Also, the terminal can inform of a frequency band in which the terminal supports D2D operation (for example, D2D communication) while receiving a service from a network of another RAT rather than the E-UTRAN.

The D2D operation of receiving or transmitting a D2D signal can be performed at a serving frequency or at a non-serving frequency depending on the terminal's capability. The serving frequency can be further divided into a primary serving frequency and a secondary serving frequency.

The terminal may perform D2D operation through a frequency band optimized for D2D communication by using a dedicated RF (Radio Frequency) unit or perform D2D operation by using an RF unit which can be used for cellular communication. This option can be determined according to the terminal's capability.

To ensure continuity of D2D operation, a network has to know the terminal's capability. For example, if the network has configured a specific frequency band or a band combination to the terminal, but the terminal is incapable of supporting D2D operation in the specific frequency band or band combination, the D2D operation has to be stopped. Then continuity of the D2D operation is broken. In this sense, information of a frequency band or a band combination in which a terminal supports D2D operation can be regarded as a highly important part of the UE-capability information.

Meanwhile, in case a terminal transmits information of a frequency band or a band combination in which a terminal supports D2D operation to a network by including the information in the UE-capability information, the terminal can adopt a method for adding the aforementioned information to the information of a frequency band or a band combination in which cellular communication is supported.

For example, suppose UE-capability information transmitted to a network by a terminal which does not support D2D operation (first terminal) includes information about a frequency band or a band combination in which cellular communication is supported. A terminal supporting D2D operation (second terminal) then has to provide the network with information about a frequency band or a band combination in which cellular communication is supported; and a frequency band or a band combination in which D2D operation is supported. At this time, rather than defining a new format of the UE-capability information for the second terminal, it is more efficient to add the information about a frequency band or a band combination in which D2D operation is supported to the format of the UE-capability information used by the first terminal.

Since the network can figure out the frequency band or band combination supporting cellular communication and the frequency band or band combination supporting D2D operation through the UE-capability information transmitted by the second terminal, the network can identify the frequency band in which the terminal supports D2D operation and cellular communication simultaneously.

In this way, the terminal can transmit the information about a frequency band or band combination supporting D2D operation by adding the information to the UE-capability information. In this case, the terminal provides the network with the UE-capability information once at the initial attachment, after which the UE-capability information is managed by the network. For example, the UE-capability information is managed by the network when handover occurs due to the movement of a terminal or at the time of RRC state change.

On the other hand, the terminal may transmit information about a frequency band or band combination supporting D2D operation to the network each time the RRC state is changed. For example, each time the RRC state is changed from the RRC idle state to the RRC connected state, the terminal can transmit the information about a frequency band or band combination supporting the D2D operation to the network. Also, in case handover occurs due to the movement of the terminal, too, the terminal can transmit information about a frequency band or band combination supporting the D2D operation to the network. The aforementioned method is similar to the method for informing of MBMS-related information.

Either of the two methods above can be used equally, but taking into account the fact that a frequency band or band combination supporting D2D operation is not changed while a terminal is connected to a network and that signaling overhead is small, the first method can be considered to be more convenient.

In what follows, described will be a specific embodiment of a method for including a frequency band or band combination supporting D2D operation in the UE-capability information.

For example, if a terminal supports D2D operation in a single frequency band, the frequency band can be added to a combination of frequency bands supporting cellular communication. In other words, a new element representing a frequency band supporting D2D operation is added to existing elements representing frequency bands supporting cellular communication.

In this case, it is not necessary to signal UE-capability information separately to inform of a frequency band or band combination supporting D2D operation. It should be noted that a method for informing of the UE-capability information has been already described with reference to Tables 4 to 6.

Meanwhile, when a terminal supports D2D operation in a frequency band or band combination in which cellular communication is performed, the terminal can additionally inform of an indicator indicating whether the D2D operation and the operation due to cellular communication are performed together according to the TDM (Time Division Multiplexing) scheme only.

For example, suppose D2D operation and operation due to cellular communication are supported simultaneously at a first frequency. In this case, a subframe in which D2D operation can be performed may be confined only to the subframe in which cellular communication is not scheduled. In other words, D2D operation cannot be performed in the subframe scheduled for cellular communication. The aforementioned operation can be informed through the indicator.

On the other hand, when a terminal supports D2D operation in a frequency band or band combination in which cellular communication is performed, the terminal may inform through the indicator that D2D operation and the operation due to cellular communication can be performed without the aforementioned limitation. For example, the terminal can inform that D2D operation can be performed in a specific subframe irrespective of whether cellular communication has been scheduled for the sbuframe.

In the absence of the indicator, a terminal can consider that D2D operation can be performed in a specific subframe belonging to a frequency band supporting D2D operation and cellular communication simultaneously irrespective of whether cellular communication has been scheduled in that subframe.

Similarly, in the absence of the indicator, the terminal can consider that D2D operation and cellular communication can be performed only through the TDM scheme in the frequency band supporting D2D operation and cellular communication simultaneously.

Meanwhile, implication of a frequency band supporting D2D operation can be interpreted differently according to whether information of a frequency band or band combination supporting D2D operation has been added to the information of a frequency band or band combination supporting cellular communication.

In other words, in case a frequency band or band combination supporting D2D operation is the same as or included in the frequency band or band combination supporting cellular communication, it can be considered that D2D operation and operation due to cellular communication can be performed only through the TDM scheme.

In case a frequency band or band combination supporting D2D operation is not included in the frequency band or band combination supporting cellular communication, it can be considered that D2D operation and operation due to cellular communication can be performed without scheduling limitation. In other words, D2D operation can be performed irrespective of whether cellular communication has been scheduled for a specific subframe.

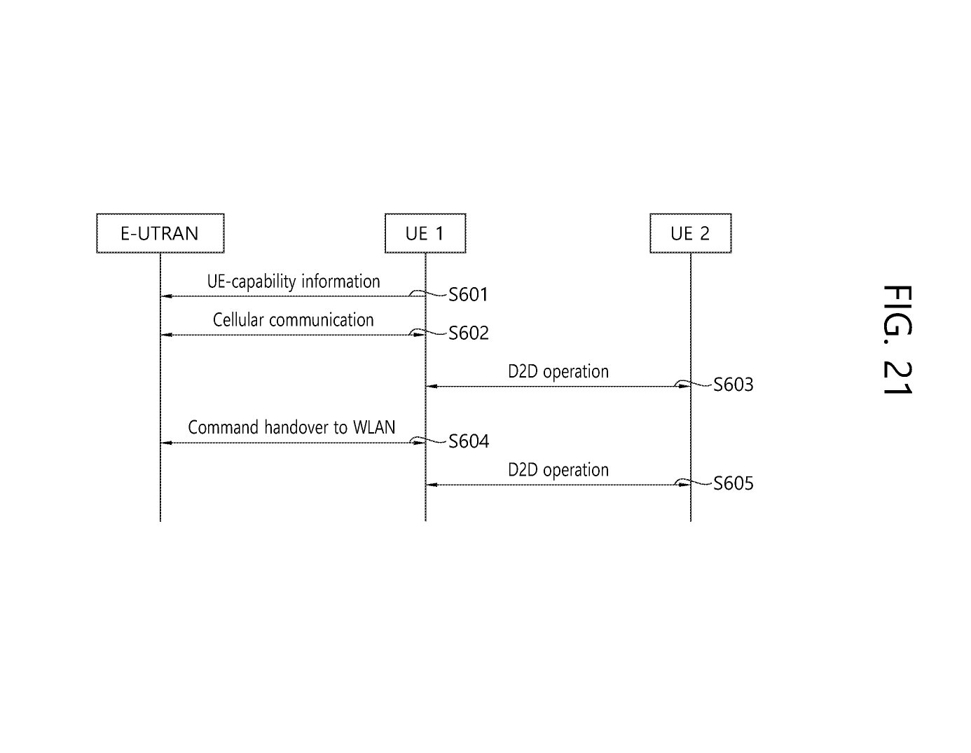

FIG. 21 illustrates a D2D operation method of a terminal when a method of FIG. 20 is applied.

With reference to FIG. 21, terminal 1 transmits UE-capability information to the E-UTRAN S601. The UE-capability information can include the aforementioned RAT support information and D2D band information.

For example, terminal 1 can transmit RAT support information indicating that the terminal 1 supports D2D operation in WLAN and D2D band information representing a frequency band in which the terminal 1 supports D2D operation by including the aforementioned information in the UE-capability information.

The E-UTRAN and terminal 1 can perform cellular communication S602.

Terminal 1 can terminal 2 can perform D2D operation S603.

In the E-UTRAN, traffic can be increased, or communication quality with the terminal 1 can be deteriorated. In this case, it may be preferable for the E-UTRAN to hand over the terminal 1 to a different RAT.

The E-UTRAN can know from the UE-capability information received from the terminal 1 that the terminal 1 supports D2D operation even in the WLAN. Therefore, the E-UTRAN can know that continuity of D2D operation can still be ensured even if the terminal 1 is handed over to the WLAN.

Therefore, the E-UTRAN transmits a command to the terminal 1 to hand over to the WLAN S604.

The terminal 1, after handing over to the WLAN, can still perform D2D operation with the terminal 2 S605.

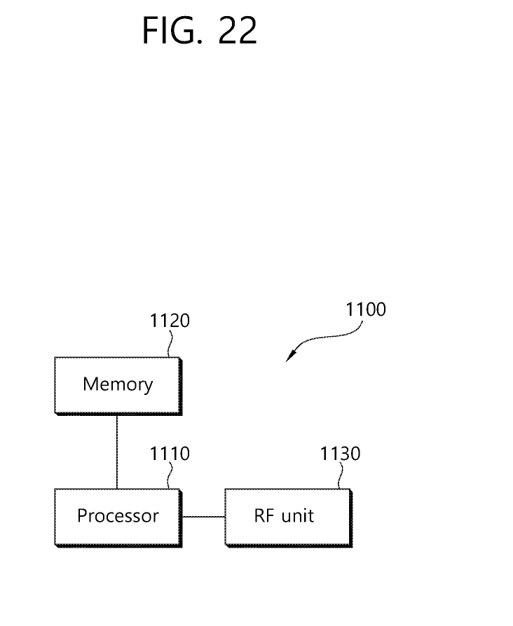

FIG. 22 is a block diagram illustrating a terminal in which an embodiment of the present invention is implemented.

With reference to FIG. 22, a terminal 1100 comprises a processor 1110, memory 1120, and RF (Radio Frequency) unit 1130. The processor 1110 implements a proposed function, process, and/or method. For example, in case a terminal operating through the first 1 RAT receives a service from a network of the second RAT, the processor 1110 can generate RAT support information informing of whether D2D operation is supported and transmit the generated RAT support information to the network of the first RAT.

The RF unit 1130 is connected to the processor 1110 and sends and receives radio signals.

The processor may include Application-Specific Integrated Circuits (ASICs), other chipsets, logic circuits, and/or data processors. The memory may include Read-Only Memory (ROM), Random Access Memory (RAM), flash memory, memory cards, storage media and/or other storage devices. The RF unit may include a baseband circuit for processing a radio signal. When the above-described embodiment is implemented in software, the above-described scheme may be implemented using a module (process or function) which performs the above function. The module may be stored in the memory and executed by the processor. The memory may be disposed to the processor internally or externally and connected to the processor using a variety of well-known means.

What is claimed is:

1. A method for D2D (Device-to-Device) operation executed by a terminal in a wireless communication system, a method comprising:
generating RAT support information informing of whether the terminal supports D2D operation in case the terminal operating in a first RAT (Radio Access Technology) receives a service from a network of a second RAT; and
transmitting the RAT support information to the network of the first RAT.

2. The method of claim 1, wherein the RAT support information is transmitted being included in UE (User Equipment)-capability information of the terminal.

3. The method of claim 2, wherein the UE-capability information further includes D2D band information indicating a frequency band or a combination of frequency bands in which the terminal supports D2D operation.

4. The method of claim 1, wherein the D2D operation is D2D communication.

5. The method of claim 1, wherein, in case the terminal receives a service from a network of the second RAT, the RAT support information informs of whether the terminal supports D2D operation with respect to a frequency band or a combination of frequency bands in which the terminal supports D2D operation.

6. The method of claim 1, wherein the first RAT is E-UTRAN (Evolved-UMTS Terrestrial Radio Access Network), and the second RAT is UTRAN (UMTS Terrestrial Radio Access Network) or WLAN (Wireless Local Area Network).

7. A terminal comprising:
an RF (Radio Frequency) unit transmitting and receiving a radio signal; and
a processor operating in conjunction with the RF unit, wherein the processor is configured to
generate RAT support information informing of whether the terminal supports D2D operation in case the terminal operating in a first RAT (Radio Access Technology) receives a service from a network of a second RAT; and
transmit the RAT support information to a network of the first RAT.

8. The terminal of claim 7, wherein the RAT support information is transmitted being included in UE (User Equipment)-capability information of the terminal.

9. The terminal of claim 8, wherein the UE-capability information further includes D2D band information indicating a frequency band or a combination of frequency bands in which the terminal supports D2D operation.

10. The terminal of claim 7, wherein the D2D operation is D2D communication.

11. The terminal of claim 7, wherein, in case the terminal receives a service from a network of the second RAT, the RAT support information informs of whether the terminal supports D2D operation with respect to a frequency band or a combination of frequency bands in which the terminal supports D2D operation.

12. The terminal of claim 7, wherein the first RAT is E-UTRAN (Evolved-UMTS Terrestrial Radio Access Network), and the second RAT is UTRAN (UMTS Terrestrial Radio Access Network) or WLAN (Wireless Local Area Network).
